(19) United States
(12) Patent Application Publication
(10) Pub. No.: US 2010/0030350 A1
(43) Pub. Date: Feb. 4, 2010

(54) System and Method for Analyzing Data From Athletic Events

(75) Inventors: Gregory House, Doylestown, PA (US); Gene Rossi, Hamilton, NJ (US); Yuecheng Zhang, Princeton, NJ (US)

Correspondence Address: STERNE, KESSLER, GOLDSTEIN & FOX P.L.L.C., 1100 NEW YORK AVENUE, N.W., WASHINGTON, DC, 20005, US

(73) Assignee: PVI Virtual Media Services, LLC, Bethpage, NY (US)

(21) Appl. No.: 12/490,026

(22) Filed: Jun. 23, 2009

Related U.S. Application Data
(60) Provisional application No. 61/084,555, filed on Jul. 29, 2008.

(51) Int. Cl. G06F 19/00

(52) U.S. Cl. 700/91

(57) ABSTRACT

Embodiments of this invention relate to generating information from an athletic event. In an embodiment, a method includes receiving an aspect of a first object and an aspect of a second object in an athletic event. In some cases, objects may be athletes, balls, pucks, game officials, goals, defined areas, time periods or other sports related objects. Aspects may include but are not limited to, a location, motion, pose, shape or size. The method further includes determining a data representation based on the aspect of the first object relative to the aspect of the second object. In some cases, data representations may be stored in a data server. In other cases, data representations may be displayed. In another embodiment, a system includes an object tracker and a data manager. Aspects may be recorded using a sensor system.

### CROSS REFERENCE TO RELATED APPLICATIONS

This application claims the benefit of U.S. Provisional Appl. No. 61/084,555, filed Jul. 29, 2008, which is hereby incorporated by reference in its entirety.

### BACKGROUND

1. Field of the Invention

Embodiments of the present invention relate to object tracking and video analysis of athletic events.

2. Background Art

There is a disparity in the coverage of sports through statistics. Baseball and American football have a wealth of statistics that cover set plays. Other sports such as basketball, hockey and soccer also gather statistics, but because these sports are fluid and have fewer set plays, the statistics on them tend not to capture the essence of the contest. This is due in part to the fact that statistics tend to be gathered manually by humans and, therefore, focus mainly on easily noted and qualified events such as scoring a run or being struck out. Many sports are dynamic in nature and have dynamic elements that are important to the outcome of the contest but are not easily or reliably characterized by an observer. For instance, the ability of a defender to limit the effectiveness of an opponent may have a significant influence on a contest, but is not easily captured in a quantifiable, reproducible and reliable manner.

A system that tracks the athlete's positions throughout active play opens up a range of possible information that may be measured. Such a system may be used to gather that information in a variety of sports, including but not limited to, organized sports, individual or team, professional or amateur.

Early implementations of systems that capture the movement of athletes on a playing surface have tended to generate statistics that relate primarily to the motion of players and objects. Typical statistics based on motion for a particular athlete may, for instance, include: instantaneous speed, average speed, distance traveled, locations traveled to, frequency of occupation of a particular region, or time spent in a particular region.

Such systems have been described in, for instance, U.S. Pat. No. 6,441,846, which is hereby incorporated by reference in its entirety. Some statistics have used player efficiency formulas, plus/minus indications of a player's contribution, or hot spots on a basketball court. However, many elements of athletic events are not tracked. Accordingly, many statistics useful to participants and observers of an athletic event are not generated and utilized.

### BRIEF SUMMARY

Embodiments described herein refer to generating information from an athletic event. According to an embodiment, a computer-implemented method of generating information from an athletic event includes receiving a first aspect of a first object in the athletic event. The method also includes receiving a second aspect of a second object in the athletic event. The method further includes determining a data representation based on the first aspect of the first object relative to the second aspect of the second object. The method may include storing the data representation in a data server. In some cases, objects may be athletes, balls, pucks, game officials, goals, or other sports related objects. Aspects may include but are not limited to, a location, motion, or pose. Such aspects may be recorded using a sensor system. According to another embodiment, the method may include displaying an image based on the data representation.

According to an embodiment, a system for generating information from an athletic event includes an object tracker configured to determine a first aspect of a first object and a second aspect of a second object. The system further includes a data manager configured to determine a data representation based on the first aspect of the first object relative to the second aspect of the second object. According to a further embodiment, the system may include a sensor configured to receive information about a first object and a second object. In some cases, the system may include a renderer configured to display an image based on the data representation. In other cases, the system may include a data server configured to store the data representation.

Further embodiments, features, and advantages of the invention, as well as the structure and operation of the various embodiments of the invention are described in detail below with reference to accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 illustrates a system for generating information from an athletic event, according to an embodiment.

FIG. 2 shows a method for generating information from an athletic event, according to an embodiment.

FIG. 3 illustrates a diagram of a pose of an athlete, according to an embodiment.

FIG. 4 illustrates player information with respect to fixed and varying references, which can be evaluated according to an embodiment.

FIG. 5 illustrates a change in velocity of a hockey players and collision analysis, which can be evaluated according to an embodiment.

FIG. 6 illustrates shooting zones assessed by shot angle and shot distance (d), which can be evaluated according to an embodiment.

FIG. 7 illustrates determining space made for a pass via a goal pick or back tracking, according to an embodiment.

FIG. 8 illustrates players providing a protection shadow through positioning, which can be evaluated according to an embodiment.

FIG. 9 illustrates obstruction in passes and shots, which can be evaluated according to an embodiment.

FIG. 10 illustrates determining a threat analysis based on player positioning, according to an embodiment.

FIG. 11 illustrates determining player coverage by associating the player paths over time, according to an embodiment.

FIG. 12 illustrates determining a player's position from team formation, according to an embodiment.

FIG. 13 illustrates an example of NHL Real Time Scoring System Statistics.

FIG. 14 is a diagram of an example computer system that can be used to implement an embodiment.

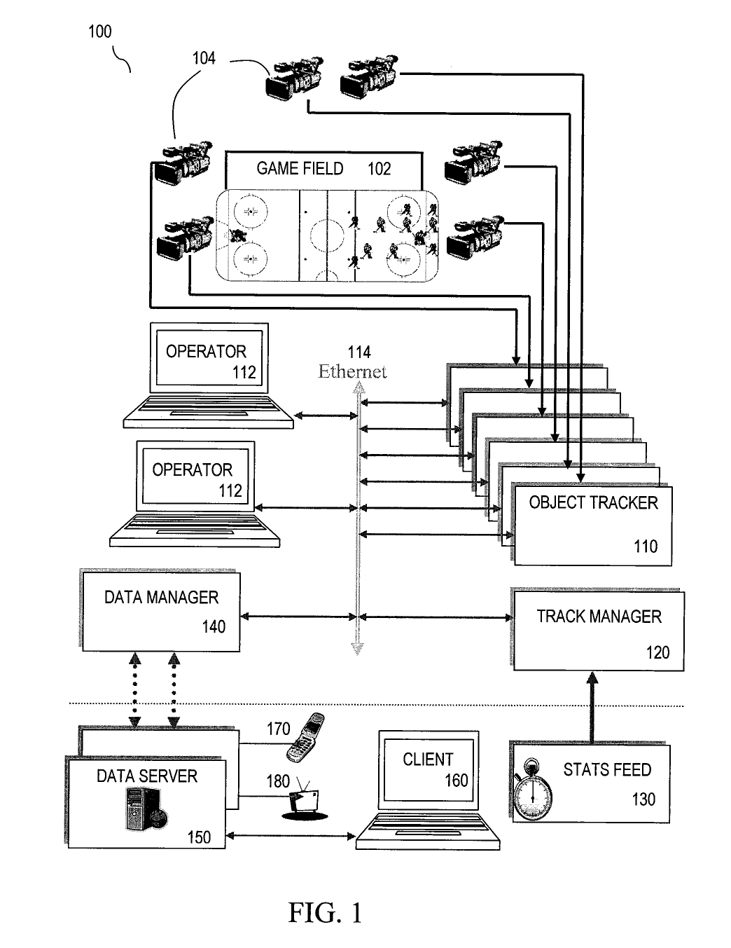

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

As described above, there is a disparity of the coverage of sports through statistics. Many statistics useful to participants and observers of an athletic event are not generated and utilized. This invention is useful in the analysis of organized sporting events, as well as during practice sessions in preparation for the sporting events. Specific uses may include, but are not limited to:
Broadcasters covering the event;
Network news summarizing an event;
Leagues producing official records of the events;
Coaches analysis of athlete performance at the events;
Fans generally interested in team performance
Fans interested in performance of specific players (fantasy leagues).
Team scouting (scouting prospects on behalf of teams)
Salary negotiations
Coach performance analysis
Referee performance analysis
Measuring venue specific biases of arenas or stadiums

Aspects of the invention outline a methodology for generating statistics that goes beyond direct calculations from an athlete's motion. According to an embodiment of the invention, information may be derived based upon a relationship between two or more objects. The objects may include any number of objects related to an athletic event. For example, objects may include, but are not limited to, athletes, a ball, a puck, a bat, a stick, a goal, a referee, a game field, or an area of a game field. In some cases, one object may be movable while another object is not. In other cases, both objects are movable.

According to an embodiment, certain aspects of each object may be recorded in order to determine information based upon one aspect of an object relative to an aspect of another object or objects. For example, aspects observed, received, and/or recorded may include, but are not limited to: (1) a location or motion of an athlete, (2) a location, pose, or motion of the athlete at a different time, (3) a location, orientation, or motion of a game object (ball or puck), (4) a location, pose, or motion of athlete(s) on the same team; (5) a location, pose or motion of athlete(s) on an opposing team; or (6) a location, pose or motion of official(s), or (7) a fixed spatial reference in real space. According to another embodiment, an aspect may include one or more official statistics about an athlete. Examples of an official statistic may be forced fumbles, sacks, goals, assists, touchdowns, minutes played, etc. In another embodiment, an aspect may be one or more statistics relating to an athlete's role, position, history or box score statistics. In some cases, an aspect may also be specific game field markings (e.g., face-off circle, penalty kick point), game field zones (e.g., touch down, red zone, goal zone, defensive zone, neutral zone) or a coordinate system laid over a game field. In other cases, some aspects may be predetermined. Aspects may also include view point information as described in U.S. Provisional Patent Application No. 61/083,049, which is incorporated by reference in its entirety herein.

According to an embodiment, an aspect may include a spatial aspect, temporal aspect, or a spatial-temporal aspect. In such a case, a spatial-temporal aspect may refer to aspects having to do with a location on, above or around a game field with respect to time. A spatial-temporal aspect may also include an orientation, position, dynamic characteristic, motion, pose or any other characteristic defined by where and how an object or portion of an object is positioned on, above, or around a game field.

Information based on relationships between objects or aspects of objects may be used to generate representations of data. Representations of data may include statistics, models, graphs, charts, raw numbers, or any other representation of data. In other cases, determining a data representation may include, for instance, determining a distance, a time period, a frequency, a level of difficulty, an acceleration, a momentum, an energy transfer, an amount of energy, a mass, a percentage, a speed, a success rate, a failure rate, a scoring statistic, a displacement, a formation of athletes or a play.

In some cases, data representations can be correlated with general information or received aspects about the athlete such as height, weight, mass, field position, salary, age, experiences, etc. Other measurements used to determine a data representation may include timestamps, game times, or windows of time. Such times may be associated with either object. In some cases, aspects of each object may be tracked with respect to time. For example, time values may be produced from an official time reference, game clock, wall clock or other timekeeping measure. For some embodiments, a time may be the internal time measuring mechanism associated with the computing elements either free running or synchronized with an external source such as SNTP time synchronization. In some cases, time measurements may include time before, during, or after an athletic action. In other cases, time measurements may include a time window. Such a window may include time before or after an athletic action. Examples of athletic actions include scoring, steals, fouls, penalties, blocks, kicks, scoring attempts, shots, passes, changes of possession, collisions, tackles, player reactions, etc.

These measurements can be combined with other observed measurements. Such measurements may include, but are not limited to:
Distance from locations on the playing surface (e.g., goal), the boundary of the playing surface (e.g., side line), or sports structures (goal posts or basketball hoop)
Containment in a spatial zone on the playing surface (red zone in American football, offensive/defensive zone in hockey, paint area in basketball)
Time reference according to the game clock (seconds/minutes since start of game, last stoppage of play, remaining in the game, last points scored, etc.)
Within temporal zone according to game clock (third period, first half, etc.)
Externally categorized events within the event (kick, pass, tackle, run, etc.)
External manually generated events (goal kick, touch down, etc.)
Data gathered at other events in the same season, or other seasons, possibly for the purpose of establishing trends.

According to an embodiment, system 100 may be used to generate information about an athletic event and its components. System 100 may include a sensor system 104. Sensor system 104 may include one or more sensors to receive information relating to an athletic event on game field 102. This information may include information about objects in the athletic event. These objects can include one or more athletes, game objects, game field objects, etc. In most cases, this information includes video signals or images. This information may also include other information such as sensor position, angle, height, location relative to game field 102, time, or any other information related to the athletic event. Game field 102 may refer to a playing field, natural field, artificial field, court, ice rink or any other athletic playing surface.

According to an embodiment, sensor system 104 may include one or more cameras. In some cases, sensor system 104 may include multiple prosumer, or professional-grade, high definition (HD) cameras mounted in different locations in an arena/stadium, each covering a portion of the playing surface of game field 102. In a further embodiment, sensor system 104 may include non-visual object sensors. In other cases, sensor system 104 may include wireless sensors, global positioning system (GPS) sensors or radio frequency identification (RFID) sensors. In some cases, sensor system 104 may include a mobile device, such as a smart phone or electronic tablet. Sensor system 104 may include any other sensors to record signals and information about an athletic event and to detect, observe or track objects. In another embodiment, sensor system 104 may be configured to record information from the athletic event on game field 102.

Sensor system 104 may be coupled to object tracker 110, according to an embodiment. Sensor system 104 may provide media signals or object information to object tracker 110. According to an embodiment, object tracker 110 may be configured to provide an aspect of an object in an athletic event. Aspect information may be provided to data manager 140. According to an embodiment, object tracker 110 may be configured to receive an aspect of an object in an athletic event. Object tracker 110 may also be configured to receive a second aspect of a second object in the athletic event. In another embodiment, object tracker 110 may be configured to receive this information from an external source other than sensor system 104. Such a source may be another database or media stored on a disc, tape, memory or other storage device. In yet another embodiment, sensor system 104 may extract data from recorded media or a recorded broadcast of an event.

In some cases, there may be more than one object tracker 110, each coupled to one or more sensors of sensor system 104. In another embodiment, object tracker 110 may be configured to analyze sensor signals to generate a representation for one or more objects. In most cases, a sensor signal may be a video signal. In a further embodiment, a sensor to representation mapping may be achieved using a sensor model created, in part, by a calibration process. Object tracker 110 is described in further detail in U.S. patent application Ser. No. 12/403,857, which was filed on Mar. 13, 2009 (“the '857 application”), which is incorporated by reference in its entirely herein.

In an embodiment, object tracker 110 may be configured to determine aspects of objects. In some cases, object tracker 110 may determine aspects of objects based on an analysis of a received video signal. This may include locating and tracking one or more portions or characteristics of one of more objects. In another embodiment, object tracker 110 may be used to record a number of characteristics of objects in an athletic event in order to form image representations. For example, object tracker 110 may record a location, motion or pose of one or more athletes in the athletic event. This may include receiving images or information on certain sections or parts of an athlete. Object tracker 110 may also record a location, orientation or motion of an object in the athletic event. In some cases, each respective aspect may be recorded relative to an official time reference of an athletic event. In a further embodiment, object tracker 110 may refer to a system of object trackers.

In other cases, object tracker 110 may record information about a certain area of game field 102 or a certain area above game field 102. Aspects of an area may include a size, shape, time duration, or frequency of an area. According to an embodiment, an area may be proximate to an object of an athletic event. According to a further embodiment, an area may be proximate to or include one or more athletes.

A representation of object positions may be sent to centralized track manager 120 for data fusion, combination or processing, according to an embodiment. Track manager 120 may be coupled to object tracker 110 directly, or indirectly through a network such as Ethernet 114. Track manager 120 may be configured to align image or video tracks with a time-stamp of a game clock. According to a further embodiment, track manager 120 may be configured to receive official statistics or roster information from stats feed 130. Such information may include, but are not limited to, more familiar information such as shots, scores, steals, corner kicks, hockey hits, football passes, running back carries, etc. According to another embodiment, athletes and objects may be labeled. Such labels may include a role of each player. These labels may be combined with a current roster from stats feed 130 to identify individual tracks. In a further embodiment, track manager 120 may be configured to analyze average track times of one or more athletes in order to determine possession or a time of possession.

According to an embodiment, data manager 140 may organize track information from track manager 120 into a coherent database representation. This involves combining label information, manually generated by one or more operator interfaces 112, to augment decisions related to track management by track manager 120. Data manager 140 may be configured to transmit information to or store data in data servers 150. In most cases, data servers 150 may be located at remote locations such as a broadcast truck, broadcast center or centralized league headquarters. Data servers 150 may also be coupled directly, or indirectly over a network to client interfaces 160, 170 and 180.

Data manager 140 may receive sensor or image representations and object information from object tracker 110, according to an embodiment. Data manager 140 may determine data representations based on these sensor or image representations and object information. For example, data manager 140 may determine a data representation based on a first aspect of a first object relative to a second aspect of a second object. This data representation and other data representations may be used to generate information about an athletic event. This information may be stored in or transmitted to data servers 150.

Object tracker 110, track manager 120, or data manager 140 may be software, firmware, or hardware or any combination thereof in a computing device. A computing device can be any type of computing device having one or more processors. For example, a computing device can be a workstation, mobile device (e.g., a mobile phone, personal digital assistant, or laptop), computer, game console, set-top box, kiosk, embedded system or other device having at least one processor and memory.

Information may also be delivered to client interfaces 160, 170 or 180. According to an embodiment, client interfaces 160, 170 and 180 may include a data terminal for broadband applications. In such a case, data can be streamed from data server 150 to end-users for use on portable mobile devices such as mobile device 170. In some cases, each data server 150 may support one or more client interfaces 160, 170 or 180. Data may also be provided to client interfaces 160, 170, and 180 directly from data manager 140.

Data representations may help in the generation of images and statistics. For example, video or still images may be displayed on a screen of a client 160, television 180 or personal mobile device 170. Client interfaces 160, 170 and 180 may include a graphics engine for broadcast. Client interfaces 160, 170 or 180 may also include a renderer configured to display an image based on a data representation. In some cases, a renderer will help to display an image during a live broadcast of the athletic event. According to an embodiment, a renderer may be used to display an image within a larger image of the event. For example, a graphic picture or statistic pertaining to an athlete may be shown on or near an athlete during a display of the athletic event. In other cases, images and video may be displayed subsequent to the occurrence of the event. According to another embodiment, an image may include an set of images or video clips. Images and video clips may be labeled or tagged based on a data representation. Labeling and tagging may also be performed with values, official statistics or any other useful information.

In many cases, data representations may be used to calculate a measurement related to an athletic event. For example, determining a data representation can include determining a distance, time period, frequency, level of difficulty, acceleration, momentum, energy transfer, amount of energy, mass, percentage, speed, success rate, failure rate, scoring statistic, or displacement. These measurements may be provided by data server 150. In some cases, these measurements can be provided directly from data manager 140. According to a further embodiment, measurements can be derived at client interfaces 160, 170 and 180 based upon received information. In other cases, data representations may include a count or number of occurrences of an event. Statistics may be generated from accumulations of events.

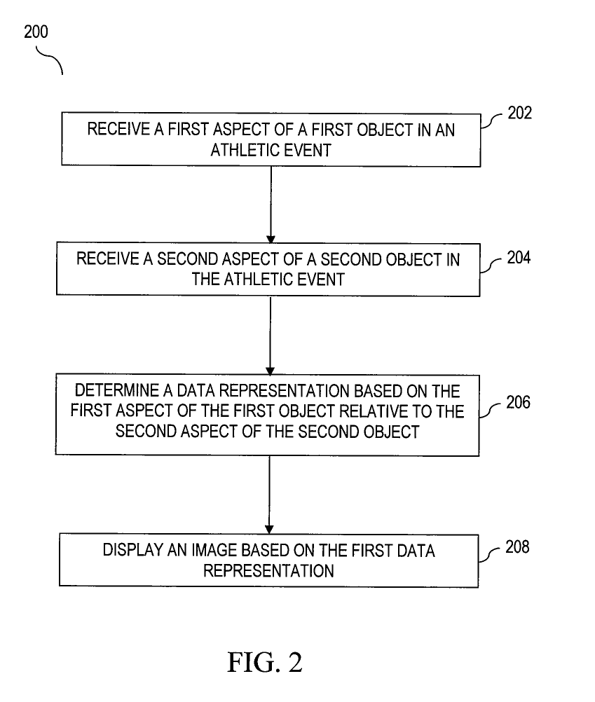

FIG. 2 illustrates a flowchart of an exemplary method for generating information from an athletic event, according to an embodiment. This flowchart is provided for illustration purposes only and includes steps which may be performed in a different order than shown in FIG. 2. In step 202, a first aspect of a first object of an athletic event is received. In step 204, a second aspect of a second object is received. According to an embodiment, steps 202 and 204 may be performed with object tracker 110. According to a further embodiment, steps 202 and 204 may be assisted by sensor system 104. In some cases, steps 202 and 204 may be assisted by track manager 120.

In step 206, a data representation is determined based upon the first aspect of the first object relative to the second aspect of the second object. Aspects of this invention use the relationship between different aspects of two or more objects to generate statistics that may have been previously unavailable. Some of these statistics may be of a “higher order” or “second order,” or beyond the usual quantifiable statistics provided, for example, in a box score or stats sheet normally used by broadcasters or consumed by the average sports fan. According to an embodiment, step 206 may be performed by data manager 140.

In step 208, an image is displayed based on the data representation. In some cases, this image is merely a word or number displayed on an electronic screen or printed in hardcopy. For example, the image may be a difficulty rating number for a pass that immediately results in a hockey goal, displayed on mobile device 170. In other cases, the image may be a picture. For example, the image may be a colored polygon area proximate to a defender, prior to the scoring of a hockey goal. This image is displayed simultaneously with a showing of a hockey game on an NHL scout's office television. According to an embodiment, automatically displaying can refer to displaying an image without user intervention. According to another embodiment, user intervention may take place prior to or during an automatic display. Step 208 may be assisted by a renderer in client interface 160, 170 or 180.

Further embodiments of the invention, described below, will illustrate data representations that may be determined based upon an aspect of a first object relative to a second aspect of a second object. For example, a first aspect may be a location of an athlete and a second aspect may be a location of an object. In another example, a first aspect may be a location of an athlete and a second aspect may be a location of a second athlete. In some cases, an aspect may be a pose of an athlete. In other cases, an aspect may be a location of an athlete or object during a certain event, such as the location of a basketball shot by an athlete. Embodiments described herein may include examples involving sports like hockey, basketball and football. However, it should be understood that these and other embodiments may involve any type of athletic event are not necessarily limited to the sporting events provided in the examples.

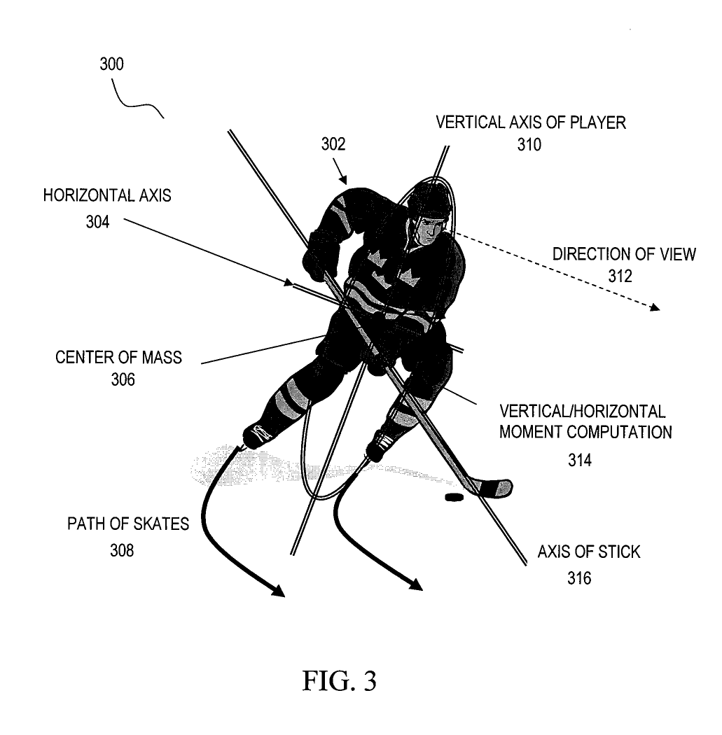

Many aspects of objects can be received or recorded. For example, location and motion are aspects. A motion may include a speed, direction, speed and direction, trajectory, acceleration, or path of an object. A motion may also include instantaneous speed, average speed, distance traveled, locations traveled to, frequency of occupation of a particular region, or time spent in a particular region. In some cases, an observed aspect of an object may be a pose of an athlete. FIG. 3 illustrates some of the measures that can be extracted related to the pose 300 of player 302, according to an embodiment. For example, moment computations 314 can be used to find the center of mass 306, the vertical 310 and horizontal 304 major axes of player 302 and the second order vertical and horizontal moments. This can give a clear indication of the direction a skater leans, and can be used as part of analyzing collisions and the ability of a player to stop or receive passes or shots. The position and axis of the stick can be an indicator of how engaged a player is in checking opponents as well as fighting over the puck. The direction and orientation of the player's view 312 can be an indicator of whether a defensive player is aware of threats, and whether an offensive player is aware of opportunities. This analysis can be coupled with directional information ascertained from the player's path.

Pose can be used to reveal information about a player's stance, posture, position, attitude and orientation, according to an embodiment. It can involve the determination of 3D positions of portions of the player: head, limbs, torso, hands, feet, as well as equipment used by the player. For example, the position and direction of a defenders skate 308 and stick 316 can be a strong indicator whether the player will block a pass. In some cases, pose can employ instantaneous measurements or be measured and tracked over a period of time. Pose analysis can help coaches to identify problems in a player's pose that affect the player's performance. Pose can be useful in identifying a player's ability outside of typical statistics such as steals or goals scored. Pose can also be used to assess mechanics of a player taking a shot, blocking a shot or pass, making or receiving a pass, kicking the ball, running a route (football), getting a rebound (basketball), etc.

Analysis of pose over time can be used to ascertain performance of a defensive player relative to an offense player, according to an embodiment. For example, in football, wide receivers may use body movements associated with pose to “fake” out the defensive coverage and create space to receive a pass. Analysis of the pose of both the offense and defense may indicate how the receiver “created space” to catch a pass. In basketball, an offensive player may create space to take a shot by first faking the motion of a shot and then driving by the defender when the defender commits to blocking the fake shot. In hockey, an offensive player in a break away may wait until the goalie changes pose such as dropping to his knees prior to taking a shot. Pose analysis over time with respect to the shot may indicate whether the shooter took the shot at the optimum moment.

In other cases, an aspect may be a motion of an athlete or an object. There are a variety of ways to determine motion from sensor representations. Consider a camera based method, according to an embodiment, that generates (from the input image) a binary mask denoting the pixel location of foreground objects in the scene. A simple object tracking approach could be define current object position by finding the centroid of non-zero mask pixel around the previous object position. Using cartisean coordinates (x,y) on the camera screen, the previous object position (x0,y0) and the current position (x1,y1) would constitute a spatio-temporal trajectory. The speed can be derived, from the distance between the coordinates divided by a time difference, by analyzing the trajectory with respect to time.

An alternate approach is to derive motion from displacement alone. Consider representing the change in object positions in polar coordinates (rho,theta) on the screen centered on the previous object position, according to another embodiment. The coordinates of the current object position (rho1,theta1) represent a displacement and direction of displacement since the previous object position. As the frame to frame matching is performed, a displacement can be estimated by forming a histogram of distance to candidate mask pixels. The range of distances with the largest frequency will likely correspond to a new location of the object. A family of motion statistics can be derived from the displacement value (rho) alone, without computing the direction. Instantaneous speed can be computed from spatial displacement (rho) by dividing time between the input image and time of previous object position. Other motion statistics such as average speed, instantaneous acceleration, peak speed, distance traveled, etc. can be derived from a series of instantaneous speed values. The direction of displacement (theta1) can be computed for the center of the polar coordinates in the next interation. In some cases, motion can be determined based on locations of an object and one or more measurements of the object at certain points in time.

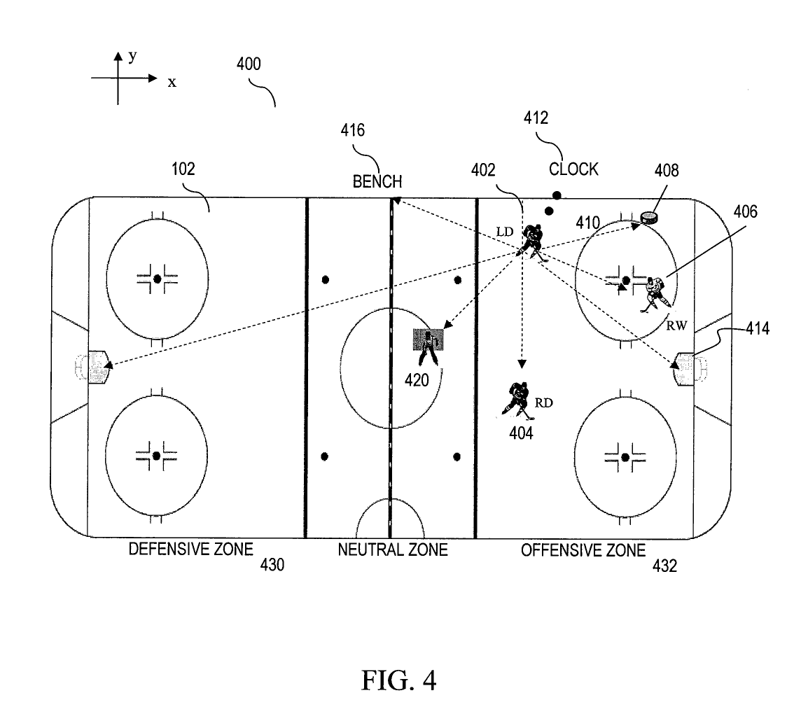

It is useful to generate statistics that capture the complex interaction of athletes during games. FIG. 4 outlines an example of relationships that affect athlete performance in a team sporting event. First, game clock 412 allows an athlete's performance to be subdivided into time epochs, such as the first, second or third periods. Second, the proximity 410 of athlete 402 relative to game puck 408 can be an indicator of ability. Third, the ability to work it unison with other team members (such as defensemen 404 in hockey) is a measure of a good player. For example, offensive players act in unison to execute play sets, such as the post up play set in basketball. Fourth, the ability to cover a player on the opposing team 406 is important, such as double teaming star player 406. The average or accumulative distance between players on the offense and the nearest defender may be an indication of how well the defense is covering the offense. Fifth, the official's position 420 when calling an infraction against an athlete can be an indicator of the validity of a foul. Finally, the athlete's location 402 relative to fixed points on the playing surface (side-line 416, goal 414, etc.) can be useful for establishing performance (i.e. how well protecting the goal). The combination or average distance of multiple players on the same team from a fixed point (side-line 416, goal 414, etc.) may be indicator of team performance (i.e. how well protecting the goal). A spatial area is useful for categorizing statistics, such as offensive/defensive zones 430 and 432 of game field/rink 102 shown in FIG. 4.

A useful mechanism to simplify a series of complex performance metrics for athletes is to derive an index from a combination of the indicators, according to an embodiment. An index may include a value or number such as a score, value, rating or grade. For instance, a quarterback rating may be described as an index. In an example, suppose we had a series of quantitative measures qᵢ, an index Q can be found through a weighted combination

$$Q = {\sum }_{i} {w}_{i} {q}_{i}^{ni}$$

wᵢ is a linear scaling factor that weights the relative components and nᵢ is an exponential term that vary the dynamic range of the individual components. It is useful to normalize the index to a reference performance level (i.e. average player, etc.), and clamp and scale the value to a desired range such as 100 for a quarterback rating. A generalized formulation for combining the measures would be

$$Q = {\sum }_{i} {w}_{i} {f}_{i} ( {q}_{i} ) ,$$

where fᵢ is an arbitrary function, possibly involving the subtraction of a bias and clamped to range. A more generalized formulation would be Q=f(q₁, . . . , q_{N}) where f is an arbitrary function of N aspects (q₁, . . . q_{N}) of objects.

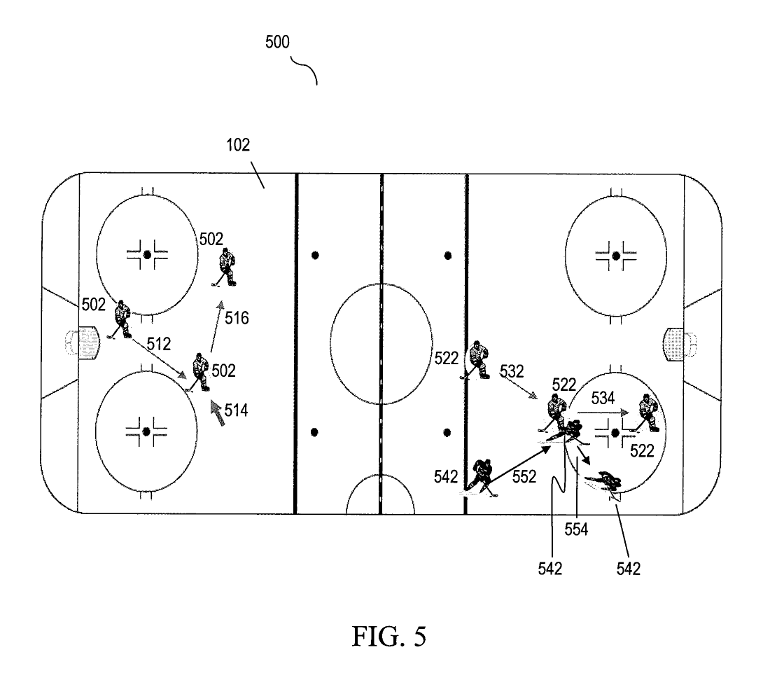

A key consideration in the fitness of athletes in a number of sports is the ability to move quickly with agility around the playing surface. This often involves avoiding member of the opposing team, which contributes to the overall fatigue of the athlete. FIG. 5 considers the effect of a player changing direction during a hockey event. This can be observed by system 100, according to an embodiment. In this simple model, player 502 has initial velocity of V_{initial 1} 512 and final velocity V_{final 1} 516 after direction change. Given the mass (weight) of the player is m₁, the change in momentum and energy can be found as

Δρ=ρ_{final}−ρᵢₙᵢₜᵢₐₗ=m₁V_{final1}−m₁Vᵢₙᵢₜᵢₐₗ₁=m₁(V_{final1}−Vᵢₙᵢₜᵢₐₗ₁)

ΔE=E_{final}−Eᵢₙᵢₜᵢₐₗ=m₁V_{final1}²−m₁Vᵢₙᵢₜᵢₐₗ₁²=m₁(V_{final1}²−Vᵢₙᵢₜᵢₐₗ₁²)

In order to estimate the energy expenditure to change direction, it is useful to consider the force exerted 514 to change direction. This is simply function of acceleration:

$${F}_{1} = {m}_{1} {a}_{1} = \frac{{m}_{1} ( {V}_{final 1} - {V}_{initial 1} )}{Δ t}$$

Δt is the time necessary to cause the change in velocity. Energy expenditure is

$$E = F Δ d = {m}_{1 } {a}_{1} Δ d = {m}_{1} ( {V}_{final 1} - {V}_{ initial 1} ) \frac{Δ d}{Δ t} .$$

If we approximate

$$\frac{Δ d}{Δ t}$$

using the average velocity over the time interval ∫V(t)dt, the energy

$$E = {m}_{1} ( {V}_{final 1} - {V}_{ initial 1} ) \frac{\int ( V ( t ) d t}{Δ t} .$$

The energy calculations above have positive or negative values depending on direction, and the corresponding energy expenditure for accelerating (positive) or de-acceleration (negative).

It is possible to get a general idea of the physical shape of athletes through the energy expended in moving around the field. For most sports that involve running or sprinting, energy expenditure can be described by a function of athlete's speed multiplied by time:

E=function(V)*time→scale*(Speed−min Speed)*time

In this case, the energy is a function of velocity above a minimum speed, multiplied by a scale factor and multiplied by length of time. A player moving at slower speeds such as a walk or jog can be in recovery mode, from a recent faster movement. Consequently, player energy should be considered from a short-term basis (how long to recover for the next sprint) and longer-term basis, how well maintain movement for sustained time. Expenditure of energy in ice hockey follows the paradigm of running sports: sprinting, skating, gliding and stopping.

Alternate measures of athletic performance in moving around the playing surface include cumulative distance. This can be observed by system 100, according to an embodiment. This applies to most sports, and can be segmented: individual/team total distance covered (number of steps taken), individual/team distance covered in quarter/half/period. Measures for speed alone include among others: time for team to cover event (NFL kickoff, basketball defense to offense transition, etc.), average player/team speed, maximum player/team speed, maximum player/team acceleration, team speed for each lineup, time spent sprinting, time spent running, time spent walking, time spend accelerating, changes between quarters/periods/half, ball speed. In a further embodiment, these can be combined as part of an index that quantifies an athlete's stamina.

Collisions impacts may be interesting to fans of collision sports such as Australian Rules football, American football and ice hockey. Incidental impacts can be useful as part of performance ratings in soccer and basketball, and to a lesser extent baseball. FIG. 5 also illustrates some basic physics of a hockey collision, which can be observed according to an embodiment. Suppose we have player P₂ 522 moving at an initial velocity Vᵢₙᵢₜᵢₐₗ₂ 532 and player P₃ 542 moving at initial velocity Vᵢₙᵢₜᵢₐₗ₃ 552. After the collision, suppose player P₂ 522 moving at a final velocity V_{final2} 534 and player P₃ 542 moving at final velocity V_{final3} 554. Given the mass (weight) of P₂ 522 and P₃ 542 are m₂ and m₃ respectively, the momentum absorbed by the impact is the change of momentum or

Δρ=|Δρ₂|+|Δρ₃|=m₂|(V_{final2}−Vᵢₙᵢₜᵢₐₗ₂)|+m₃|(V_{final3}−Vᵢₙᵢₜᵢₐₗ₃)|

Note that velocity is a vector, which both x and y directional components, which have to be combined independently. The vector force (F) can be derived using a time of impact (Δt) estimate by empirical data,

$${F}_{2} = \frac{Δ {ρ}_{2}}{Δ t} = \frac{{m}_{2} ( {V}_{final 2} - {V}_{ initial 2} )}{Δ t} , {F}_{3} \frac{{m}_{3} ( {V}_{final 3} - {V}_{ initial 3} )}{Δ t} .$$

Alternately, the average scalar force (F) can be derived from change in energy (ΔE) using the distance (Δd) the change is applied,

$$F = \frac{Δ E}{Δ d} = \frac{{m}_{2} ( {V}_{final 2}^{2} - {V}_{ initial 2}^{2} )}{2 Δ {d}_{2}} + \frac{{m}_{3} ( {V}_{final 3}^{2} - {V}_{ initial 3}^{2} )}{2 Δ {d}_{3}} .$$

In one embodiment, the data generated by collision analysis can be represented as a diagram over laying a video image or graphical image of the playing surface. The direction of the colliding players before and or after impact can be represented as arrows or trails (532, 552, 534, or 554). This may be accompanied with associated momentum values, force values, or an index generated from the momentum or force computation. This may be accompanied by diagram images or icons of the players in the appropriate location on the playing surface.

Distance can be ascertained from observing the distance covered during the time players are touching, according to a further embodiment. Creating an index from the force or momentum can also take into account a number of factors. For example:
Whether player is hit from front, side or rear (blind hit or not)
Whether player is crouched for speed or upright to slow down (pose)
The vertical center of gravity for the player (combination of height and pose)
Time players take to recover from collision and move at normal speed
Whether hits is along boards or in open ice (hockey)
Rating differently the instigator and victim of contact.

In some cases, in addition to a rating of the collision itself, collisions can be sorted and categorized by: quantity, frequency, time between, impact (measure of force and compared to real world examples), max impact force or rating, average impact force or rating, and total impact force or rating by quarter/period/half. In a further embodiment, this can be incorporated into a stamina index that incorporates the severity and frequency of the contact, as a weighted factor in an overall evaluation of physical activity. In some cases, physical exertion can be assumed (pushing and cross-checking) when players from opposing teams slow to the same location along the boards, in front of the net, or at the location of the puck. This measure can take into account the relative weights of the participants, whether double teaming is involved, the proximity of the participants, and the time of close encounter.

Another factor that affects stamina of an athlete and decrease energy levels is propelling the object (ball/puck) during a sporting event. The kinetic energy of an object with mass mₒ can be found from its velocity Vᵢₙᵢₜᵢₐₗ₂ when leaving the athlete:

$${E}_{initial} = \frac{{m}_{o} {V}_{initial 2}^{2}}{2} .$$

The energy expended to propel the object can be estimated as a scaled value of this energy measure.

According to certain embodiments, a clear indicator for rating exertion in fields sports such as football or soccer is the distance and time a ball travels in the air as well as after it strikes the ground. This applies to throws, kicks and headers (soccer). In another embodiment, distance and time of ball in the air can be used to rate the strength of the arm of a baseball fielder or football quarterback. Additional factors that can rate an athlete's performance are estimated force of impact, speed, frequency and quantity. This can be broken down by quarter, half, set play, or other interval of time. For ice hockey, speed and number of shots and passes is likely are good indicators for athlete exertion. This can be augmented by the frequency (repetition) and distance to targets. Success rate in pass and shots are indicators for skill of the originator athlete. This can be combined with the movement measures and contact measures to compute a composite stamina index. Again, individual constituents can be weighted to reflect factors in stamina that impact athlete performance.

There are a number of sports that involve getting an object (ball or puck) into a region near a playing surface with a limited area (hockey or soccer goal, football goal post, basketball hoop). A facet of these games (soccer, hockey, basketball, American football, Australian Rules football, rugby, etc.) is that the difficulty of hitting the target increases with the distance from the target. In sports that involve kicking, this is partly due to the fact that an athlete has a limited range. Often the need for accuracy of the trajectory of the ball/puck increases with distance. Possible measure for this difficulty includes target area divided by distance

$$( \frac{A}{d} ) ,$$

width or height divided by distance

$$( \frac{w}{d} or \frac{h}{d} ) ,$$

inverse tangent of width divided by distance

$$( {tan}^{- 1} \frac{w}{d} ) .$$

Each of these cases can be observed and determined, according to embodiments of the invention.

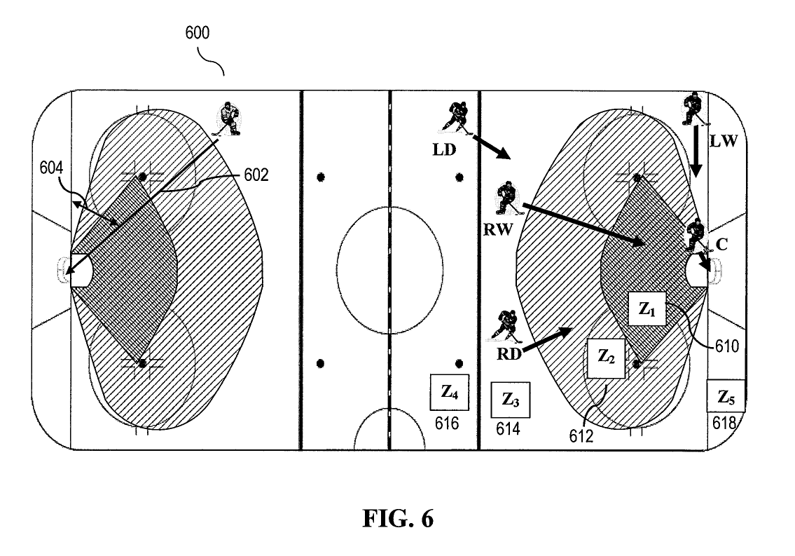

According to an embodiment, information can be determined based on a location and pose of an athlete proximate to an object within a time window of an offensive or defensive action in an athletic event. Offensive and defensive actions may include, but are not limited to, attempts to score, pass, block, retrieve a game object, steal, contact another player, avoid contact of another player, change direction, accelerate, get past another player, jump, catch, etc. For example, ice hockey (and lesser extent soccer and football) has the additional facet that it is more difficult to hit the target from a skewed angle of attack. The left side of FIG. 6 illustrates the case for a shot at distance d 602 and angle A 604. The angle A 604 attenuates the width of the goal (w): w′=w*tan(A). In a further embodiment, in combination with the shot distance measure described above, the ice can be divided into multiple shooting regions with increasing level of difficulty (Z₁ 610, Z₂ 612, Z₃ 614, Z₄ 616 and Z₅ 618). The skew angle can cause the shooting region to roll off at an angle from the goal, where as no shots are typically possible from behind the net (zone Z₅ 618). It is possible to convert this shooting difficulty into a probability measure of a shot on goal given the effective size or space of the goal, P(shot|S_{goal}), according to a further embodiment. Naturally, the success of the shot depends on the location and pose of offensive players relative to defensive players or a goal at the time. In an embodiment, a location or pose of an athlete may be evaluated relative to a location or orientation of an athlete or object.

In an embodiment, data generated by a shot difficulty analysis can be represented as a diagram over laying a video image or graphical image of the playing surface. This may include multiple shaded shooting regions with increasing level of difficulty (Z₁ 610, Z₂ 612, Z₃ 614, Z₄ 616 and Z₅ 618). The video representation may key the current location of players so they appear to be on top of the shaded regions. This may be accompanied by images or icons for the players in the appropriate location on the playing surface currently, or at the time of shot attempts on goal.

A data representation may be determined based on a motion of a first object relative to a location, motion or pose of an athlete in a time window of an athletic action, according to an embodiment. In some cases, an athletic action may be a pass, a move to get open, or a scoring attempt. For example, the concept of hitting a limited window with the ball or puck can be extended to moving targets as well. Receivers need to “make space” or “get open” for the passer to successfully connect. According to another embodiment, information may be determined based on a location, motion and pose of a first athlete in the athletic event that is in preparation for receiving an object relative to a location of a second athlete in the athletic event having possession of an object.

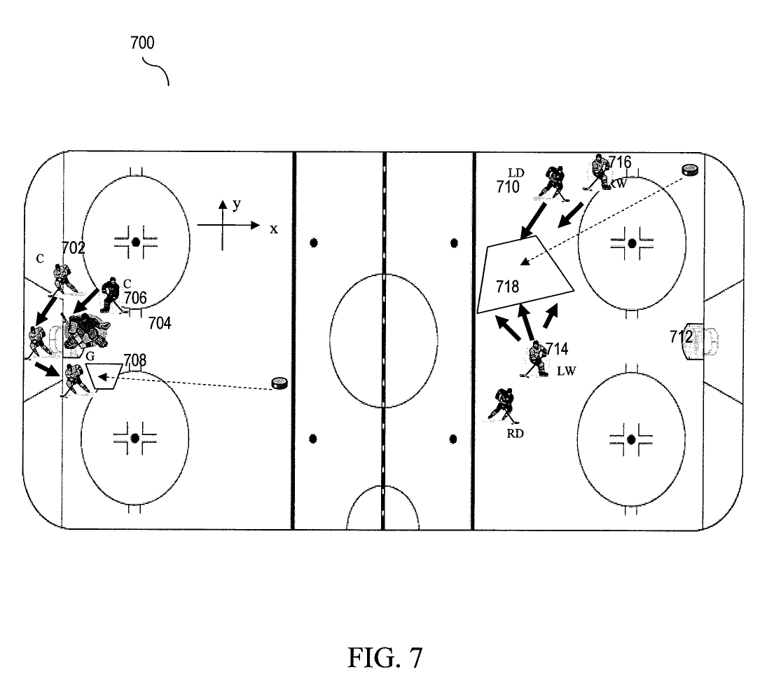

For instance, FIG. 7 illustrates two examples of a player in hockey making space to receive a pass, according to embodiments of the invention. The first example shows a center 702 using a “pick” of the goal structure 704 to shed the defender 706 covering him (center from the opposite team). This opens up a small window 708 (trapezoid on the ice) to receive a quick pass and potentially score. The pick and roll is an important mechanism in basketball for players to make space leading to successful passes and score. In another example, FIG. 7 shows a Left Defensemen 710 back-tracking away from the goal 712 to “catch a pass”. The Left and Right Wings 714 and 716 on the opposing team bound an area to receive. The area of the window 718 is permitted to be much larger by the defense since this is a less threatening location for the offense to have the puck. According to an embodiment, data representations can be determined based on a motion of a first object relative to a size, shape, time duration, or frequency of an area that the first object passes through. In some cases, the motion of the first object may include a starting point, a trajectory, or an angle of a shot in relation to a targeted destination or another athlete. In such a case, a shot difficulty index may be determined. In a further embodiment, pose analysis of the players may allow a more accurate assessment of the effective size of a region.

According to an embodiment, information may be determined based on a size, shape, time duration, or frequency of an area of a playing surface proximate to a first athlete relative to a location, motion or pose of an athlete. For example, we can measure an athlete's ability to make space by computing the area of the region around a player, as represented by trapezoids 708 and 718 in FIG. 7. The regions themselves typically are more complex shapes, roughly determined by surface area closer to the receiver than opposing team members in the vicinity. In some cases, this value can be weighted by the proximity to scoring position since this is a more desirable outcome for the offense. Another important consideration is the dynamic nature to the space window, changing in shape and size with time. For example, center (C) 706 in FIG. 7 has a limited time window to get off a shot before adjacent players quickly close up the space.

In some cases, a window may need to be large enough at the time of the pass to allow time for the pass to be received and a shot to be taken. In hockey, “one timer” is the term used to describe when a player receives a pass and takes a shot in a single motion, hence limiting the time taken. In a sport such as basketball, timing of inside passes is precise since one misstep can lead to a blocked shot. Basketball has the added dimension of height in the timing of the reception and resulting dunk of the ball. Consequently, the window size may need to be averaged over a short period of time to truly assess the space opening. In an embodiment, a data representation may be determined based on a motion of a first object relative to a pose of an athlete between a starting point of a motion of the first object and an ending point target of the motion. This motion of an object may include a shot, a pass, or a movement of a player. A starting point may be a shooter, passer or first position of a player. An ending point may be a goal, a receiver or a potential second location of a player. Some embodiments may include other types of objects in motion. Other embodiments may include a disruption of the motion of an object.

The concept of making space applies to players who maintain possession of the ball or puck, such as the running back in American football. A fake move or a pick (block) play can allow room to open up to advance the ball. In hockey and basketball, this can allow a player to make enough room to take a shot. The offensive player makes space through movement around the playing surface. The defense constrains space by blocking or stopping the paths for movement. In hockey, a player can hold onto the puck too long in a stationary position near the boards and lose possession when double teamed. According to an embodiment, this event can be modeled by a shrinking “space” window around the player. In a further embodiment, pose analysis of the players can reveal how a player was able to “make the space.” In another embodiment, information can be determined based on a motion of an athlete relative to a location and size of an area created as a result of the motion of the first object.

In one embodiment, data generated by player space analysis can be represented as a diagram over laying a video image or graphical image of the playing surface. This may include designating a region of the playing surface by a polygon (708, 718) or more complex shape, with or without internal shading. The movement of players (702) leading up to creating open space may be designated by lines or arrows, which can vary in size and color depending on speed or team affiliation. The video representation may key the current location of players so they appear to be on top of the shaded regions. The graphical image representation may be accompanied by images or icons for the players in the appropriate location on the playing surface. The above region representation may also be used to show protected regions of the playing surface, such as the polygon of defenders in hockey during a penalty kill situation.

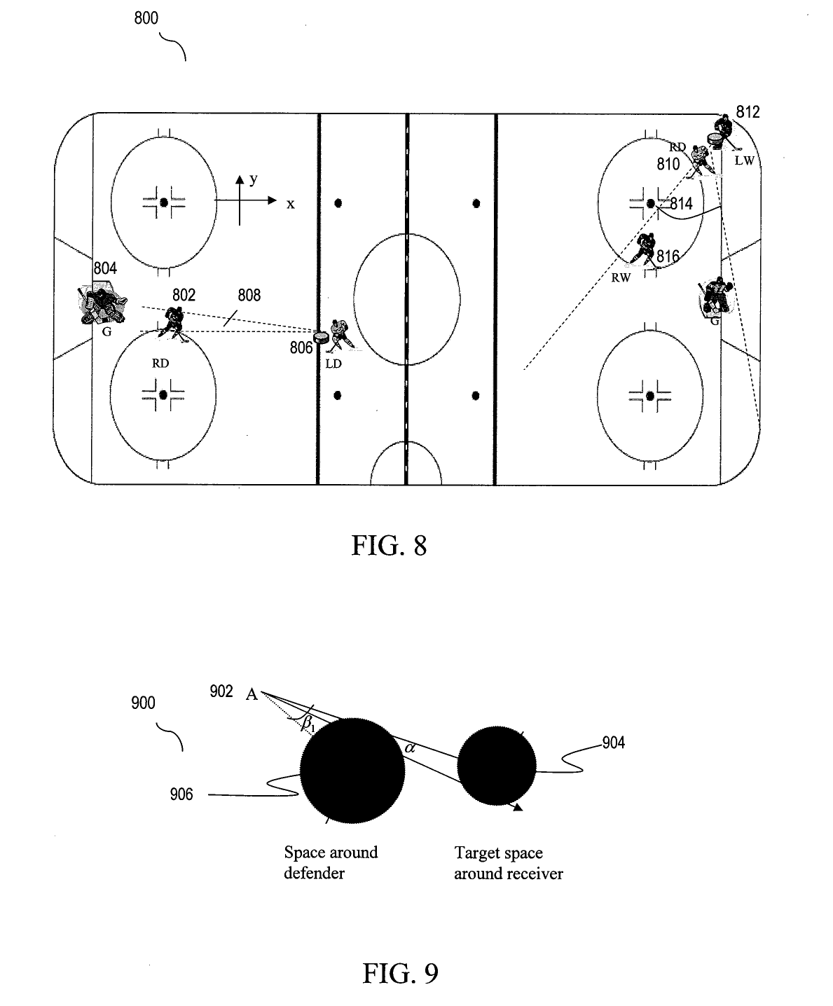

The defense has tools at their disposal to hinder the offense's ability to receive a pass or take a shot. In hockey, this can be accomplished through the positioning of defenders relative the member of the offense with the puck. In essence, the defense is using it own space to affect the outcome of the play. FIG. 8 illustrates the case of a Right Defensemen 802 positioning himself between the goal 804 and the opposing team Left Defensemen 806 with the puck. As seen, the defender “casts a shadow” on the goal through his positing. The angle 808 is rather narrow due to the large distance between the two players, but it is large enough to likely disrupt a potential shot. This can be observed using system 100.

FIG. 8 shows the Right Defensemen 810 covering the opposing team Left Wing 812 with the puck. Here, the shadow angle 814 is large enough to block a shot on goal as well as a pass to the opposing Right Wing 816. This demonstrates two points: defender positioning can stop passes, and that closer coverage of the defense on the offense limits the opportunity of the offense. The danger of being too close is the offense player may be able to get by the defense player. In some cases, information about defensive players may be generated based on a motion of a first object relative a location, motion or pose of an athlete within a time window of a disruption of the motion of the first object from an initial trajectory.

Player formations and plays based on certain formations can be evaluated or determined. According to an embodiment, a formation of a first or second set of athletes may be determined based on a location of the first set of athletes within a time window relative to a location of the second set of athletes within the time window. A set of athletes may include one or more athletes. It is possible for the first set to overlap with the second set. In some cases, each set of athletes is on the same team. In other cases, each set of athletes pertains to athletes of a different team. In a further embodiment, a play may be determined based on a location of a first set of athletes relative to a location of the second set of athletes. The play may be determined based on spacing of the athletes, roles or labels of athletes, a motion of one or more athletes during prior to or during a motion of other athletes. In some cases, a play is determined. In other cases, a play is analyzed. In these cases, the flow of a play can be observed. Plays can be compared to other plays. Plays can also be evaluated to determine how well a play is executed by one or more players. Comparisons to ideal or predetermined locations, motions or formations may be made. In some embodiments, a play comparison may involve observing aspects of athletes executing a play relative to athletes executing the play at another time, in an ideal execution scenario, or in a simulation. In some cases, an execution index may be generated.

A reaction of one or more players relative to a reaction of one or more other players may be evaluated to determine activity within or modifications of a formation or play. In an embodiment, a reaction of a second athlete may be evaluated relative to an action of a first athlete, wherein the reaction of the second athlete is in response to the action of a first athlete. This may be combined with time measurements to determine a reaction time of either athlete. A reaction may include a pose, motion, location or any combination of aspects.

In some cases, players may be evaluated as to a contribution to a play. Players may also be evaluated as to how effective a play is based on a player's presence or activity. According to an embodiment, a data representation may be determined based on a motion of a first object, such as an athlete, relative to a formation of a set of athletes in an athletic event. As a set of athletes may include one or more athletes, plays may involve a whole team or just two players of a team, as in a pick and roll situation in basketball. According to a further embodiment, this data representation may be a play or reaction to a play. In another embodiment, it may be possible to provide a real-time measure of a likelihood of a given outcome based on historical data of similar situations.

In some cases, pose analysis may contribute to evaluating an effectiveness of a play. For example, location, motion or pose of an American football cornerback relative to a location, motion or pose of a wide receiver may be used to evaluate an offensive or defensive player's effectiveness. In some cases, a new effectiveness rating may be generated based on a formula. In further embodiments, the activity of the players may be further evaluated relative to a time window of an athletic event. For example, the cornerback or wide receiver may be evaluated in a time window involving a catch, an interception, or initial contact between the players near the line of scrimmage.

In another example, quantifiable measures from the formation analysis are that distance and angle of the defense matters relative to the offense. The distance between the defense and offense determines the size of the shadow. According to an embodiment, this distance can be determined using system 100. The angle of protection A is a function of the expected width (w) of the defender and the distance of the defender, found in a similar manner to the above distance analysis

$$A = 2 {tan}^{- 1} \frac{w}{2 d} .$$

The direction or angle the shadow is cast is determined by the line between the offense and defense players. The defender positions to cast a shadow toward the goal to stop a shot or toward another opposing team member to stop a pass. These activities can be evaluated by system 100, according to an embodiment.

It should be noted that members of the offense tends to leave distance between one another so that one defender can not effectively cover two players. Also, the defenders (including goalies) shift back and forth, making the timing of a shot or pass as important as spatial accuracy. The shadow concept can be used by the offense in the form of a screen, where a member of the offense blocks the view of the goalie of the shooter. Finally, for sports such as basketball, height and arm span and timing of jumps play a role in the defense ability to protect or shadow the basket, and prevent passes to the inside. Shadows can be observed using system 100.

In one embodiment, data generated by player shadow analysis can be represented as a diagram over laying a video image or graphical image of the playing surface. This may include designating a triangle-like region of the playing surface originating from the player with the puck (808, 814) with or without internal shading. The shading may be only applied to the portion of the shadow triangle-like region behind the player causing the shadow. The video representation may key the current location of players so they appear to be on top of the shaded regions. The graphical image representation may be accompanied by images or icons for the players in the appropriate location on the playing surface. In another embodiment, the shadow representation can be applied as a light source originating from the goal or basket with the shadow cast by the defensive player onto the game field in a direction away from the goal or basket.

Passes can be rated for level of difficulty in hockey as well as other sports. A pass can be defined as successful transmission of the puck between team members across a minimum distance with a level of accuracy. In some cases, a three stage model can be employed: difficulty of initiating a pass given the space around player 1 P(pass|S₁), difficulty in continuing the pass given the space of the defenders P(pass|S_{defenders}), and the difficulty of catching the pass given the space around player 2 P(pass|S₂). This can be viewed as a series of probability where pass is a particular path in time and space:

P(pass1−>2|pass2)=P(pass1−>2|S₁)P(pass1−>2|S_{defenders})P(pass1−>2|S₂).

Appropriate values for probabilities can be derived empirically based on the space characteristics of the players involved, according to an embodiment. In another embodiment, assessments can be made based on the speed and accuracy of passes between team members with respect to the space characteristics of the passer, receiver and defenders in the area. In a further embodiment, pose analysis of the players involved should allow a more accurate determination of the space characteristics of athletes involved. In principal, shots with higher speed such as slap shots tend to have lower accuracy. More constrained regions result in hurried passes and hence less accuracy. A similar formulation can be found for shots: P(shot 1)=P(shot 1|S₁) P(shot 1|S_{defenders}) P(shot 1|S_{goalie}) P(shot 1|S_{goal}).

P(shot 1|S_{goalie}) and P(shot 1|S_{goal}) are probability of the shot passed by the goalie and the probability the shot hits the goal (see angle and distance to the goal discussion above).

Formation analysis can document missed opportunities that do not show up in manually recorded statistics. It can be straight forward to go back and analyze team positioning in the sequence of events leading up to a goal. However, it is another level of analysis to quantify the missed opportunities, both passes and shots. It is possible to record strategy changes relative to time and score of game.

According to an embodiment, information may be determined based on a location and pose of a first athlete relative to a location of a second athlete in the athletic event having possession of a scoring object. For example, it is possible to estimate the two step shooting threat experience by the goalie at a particular moment, according to an embodiment. Such an estimation may be a combination of the likelihood of a direct shot by the puck holder combined with the likelihood of pass to other skaters and their subsequent shot.

$$T = {\sum }_{n} P ( shot n \vert pass 1 \to pass n ) P ( pass 1 \to n \vert pass n ) P ( pass n )$$

P(shot n|pass1→pass n) is the probability of a shot by player n given that player n received the pass. P(pass1→n|pass n) is the probability of a successful pass to player n given a pass was attempted. For the sake of discussion, n=1 can be an indication that the passer kept the puck and moved to different position to shoot. P(pass n) is the probability of attempted pass to player n. These three quantities can be estimated through empirical analysis of pass, shot and player location data, according to aspects of the invention. A histogram of threat values over time can be used to assess the amount of missed opportunities over a period or game. According to a further embodiment, averaging this value over time can be another indicator.

FIG. 9 illustrates a detailed analysis of the probabilities associated with obstructions, according to an embodiment. At a particular passing speed, the probability of a successful pass from puck position A 902 to a player located at position B 904 can be estimated as the product of probability of the sender successfully sending the puck from position A 902 into the target area around B 904, the probability of a defender 906 failing to interfere with the puck during the pass procedure, and the probability of the receiver receiving the puck in the target area of 904. If the probability of the passer sending the puck in a direction that is a degrees from the line AB in a speed V is Pₛ(α,V), the probability of a defender 906 in the middle interfering with the pass that is in the distance dᵢ to him is P_{I}(dᵢ,V)=P_{I}(|ACᵢ| sin(α+βᵢ),V) and the probability of receiver 904 successfully receiving the puck in a distance of d to him with speed V is Pᵣ(d,V)=Pᵣ(|AB| sin α, V). Then the successful pass probability equals:

$${P}_{pass} ( V ) = {\int }_{0}^{2 π} {P}_{s} ( α , V ) {\prod }_{i} ( 1 - {P}_{I} ( \vert {AC}_{i} \vert sin ( α + {β}_{i} ) , V ) ) {P}_{r} ( \vert AB \vert sin α , V ) d α$$

According to another embodiment, a shot can be regarded as a pass to the center of a gate without a receiver; the receiving probability in the above-shown formula can be replaced by an in-gate probability as:

$${P}_{g} ( \vert AG \vert sin α , V ) = {P}_{g} ( \vert AG \vert sin α ) = \{ \begin{matrix}1 & \vert AG \vert sin α < {3}^{′} \\ 0 & otherwise\end{matrix} \\ Thus , \\ {P}_{shot} ( V ) = {\int }_{0}^{2 π} {P}_{s} ( α , V ) \prod ( 1 - {P}_{I} ( \vert {AC}_{i} \vert sin ( α + {β}_{i} ) , V ) ) {P}_{g} ( α ) d α$$

Now, three probability terms may be considered, according to an embodiment. The receiving and interference probability equals the product of two terms, the first term is the ratio of the distance that the puck passes its control area and the diameter of the control area. The second term is a velocity related term f (V). Thus

$$\begin{matrix} {P}_{r} ( \vert AB \vert sin α , V ) = \{ \begin{matrix}\frac{\sqrt{{R}^{2} - {\vert AB \vert}^{2} {sin}^{2} α}}{R} \times f ( V ) & \vert AB \vert sin α < R \\ 0 & otherwise\end{matrix} & \\ And \\ {P}_{I} ( \vert {AC}_{i} \vert sin ( α + {β}_{i} ) , V ) = \{ \begin{matrix}\frac{\sqrt{\begin{matrix}{R}_{I}^{2} - {\vert {AC}_{i} \vert}^{2} \\ {sin}^{2} ( α + {β}_{i} )\end{matrix}}}{{R}_{I}} \times f ( V ) & \vert {AC}_{i} \vert {sin}^{2} ( α + {β}_{i} ) < {R}_{i} \\ 0 & otherwise\end{matrix} & \end{matrix}$$

Although there is no close form expression for f(V), it is known that f(∞)=0, and f(x)=1, when x<ε. Different approximation can be used to estimate the actual probability in an application according to the specific requirement.

The sending probability Pₛ(α,V) is a complicated term. Its actual value is related with the many issues, such as training level, energy remains, experience and so on. However, all sending probability Pₛ(α,V) follows the following basic rules:

Pₛ(α₁,V)≧Pₛ(α₂,V) ∀α₁<α₂. a).

Pₛ(α,V₁)≧Pₛ(α,V₂) ∀V₁<V₂. b).

∫₀^{2π}Pₛ(α,V)dα=1 ∀V. c).

Thus, proper approximations of all terms are determined in real application. With all these terms determined, the single pass and shot probability can be calculated, according to an embodiment. Further, these can be combined into more complicated combined passes and shots which lead better understanding of a game.

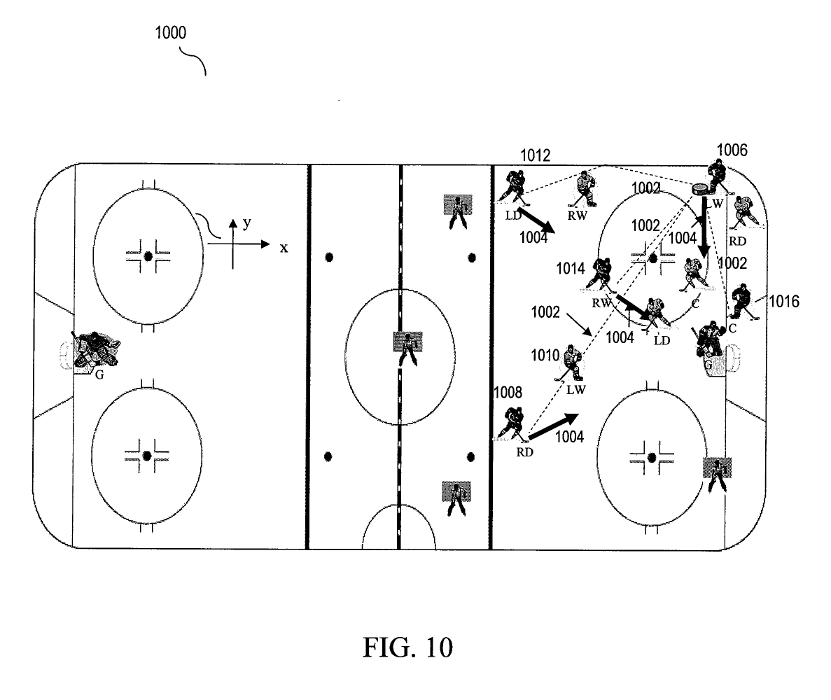

FIG. 10 is an example application for the above threat computation, according to an embodiment. Paths from the puck to potential receivers are shown in dotted lines 1002, and subsequent shots on goal are show as solid arrows 1004. A potential pass of the puck from LW (Left Wing) 1006 to RD (Right Defense) 1008 goes through the opponent (LW) 1010, so a successful pass to LD 1012 is unlikely P(pass LW→RD|pass RD)≅0 and thus chance the LW 1006 will attempt the pass is also unlikely so P(pass RD)≅0. The center 1-16 is out of position for a shot, so that P(shot C|pass C→pass C)≅0. Thus, the threat will have the form:

T=P(shot RW|pass→RW)P(pass→RW|pass RW)P(pass RW)+P(shot LD|pass→LD)P(pass→LD|pass LD)P(pass LD)

The second term should have a lower contribution given that both the pass and subsequent shot is more difficult for LD 1012, than RW 1014 who is largely open in this case.

In one embodiment, data generated by threat analysis can be represented as a diagram over laying a video image or graphical image of the playing surface. This may include designating passing lanes between offense players as arrows or lines (1002) with or without internal shading. The width, shading or color of the lines can be varied depending on the level of difficulty of the passes, or annotated with numerical values representing the difficulty. The threat on goal associated with offense players may be represented by as arrows or lines pointing toward the goal or some graphical means to highlight the player. The width, shading or color of the lines can be varied depending on the level threat level, or annotated with numerical values representing the threat level. The video representation may key the current location of players so they appear to be on top of the shaded regions. The graphical image representation may be accompanied by images or icons for the players in the appropriate location on the playing surface.

An important aspect of organized sports in the ability of athletes as a team to react and respond to changing threats. This is particularly true for sports such as soccer and hockey, which has constantly changing formations. An excellent example is the ability a team anticipates and responds to a change in possession, particularly in hockey where break-away plays can be the difference in the score. For example, for hockey, a change in possession can be detected from the average spatial location of the skaters (no including the goalie):

$$\overline{x} = {\sum }_{i} {x}_{i} , \overline{y} = {\sum }_{i} {y}_{i}$$

(xᵢ,yᵢ) are the coordinates of the ith player. If x̅ value of the skaters changes significantly in magnitude and sign, this is an indication that the flow of play has reverse likely due to a possession change. After a significant change is detected, the record of previous location over time can be assessed to find a more precise time that change of possession occurred, according to an embodiment. This point can be different temporally between the teams, indicating a faster response of one team versus the other.

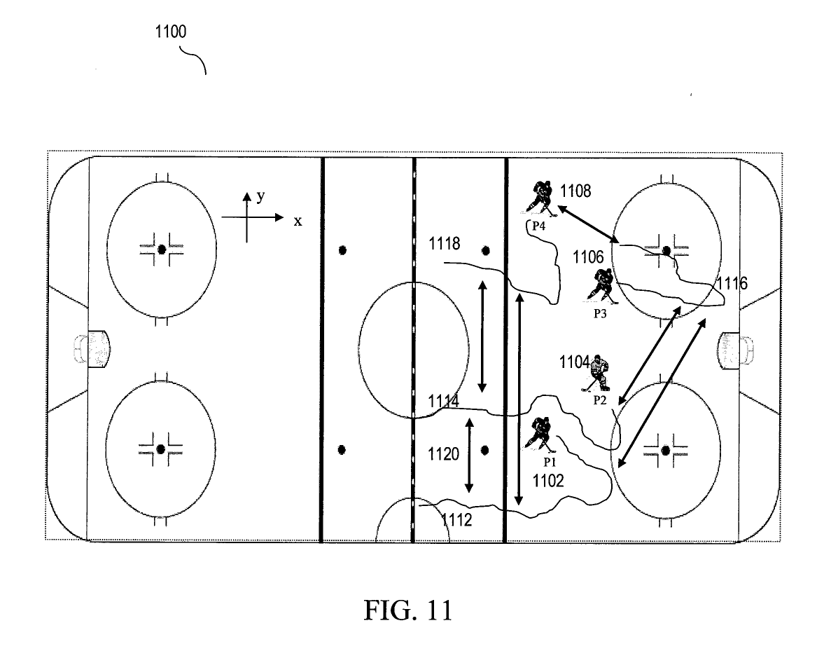

Response time can be compared between individual players, according to another embodiment. For example, FIG. 11 shows select players 1102-1108 on the ice and a representation 1112-1118 of their previous location. The autocorrelation between the historical locations of the player P₁(t) 1102 with itself can be computed from the expected value E{ } and mean location μ₁:

A₁(k)=E{[P₁(t−k)−μ₁]^{T}[P₁(t)−μ₁]}.

The expected value is computed over a range of time t. According to an embodiment, the cross-correlation 1120 between the historical location of two players P₁(t) 1102 and P₂(t) 1104 can be computed:

C₁₂(k)=E{[P₁(t−k)−μ₁]^{T}[P₂(t)−μ₂]}.

The correlation between the two signals can be found by comparing the cross-correlation to the autocorrelation response, according to an embodiment. A highly correlated signal will have strong cross-correlation signal, where a low correlated signal will have a weak response.

An alternate strategy of comparing the historical locations of two players is the expected square distance between the athletes:

D₁₂²(k)=E{[P₁(t−k)−P₂(t)]T[P(t)P₂(t)]}.

Large distance values are an indication of uncorrelated paths, or possibly poor coverage in the case of offense/defense match up. If the peak response C₁₂(k) and D₁₂(k) for is at k=0, it is an indicator that both players responded to an event on the playing surface equivalently. If the peak is shifted, this indicates that one player responded prior to the other. Large k values are also an indicator of poor coverage in cases of man to man match ups. In a further embodiment, pose analysis of the players may allow for a more accurate determination of a point that a player responds to a threat.

In one embodiment, data generated by player position over time can be represented as a diagram over laying a video image or graphical image of the playing surface. This may include designating multiple player paths as a raw trail or a smoothed curved. The width, shading or color of the lines can be varied based on team affiliation, player with the puck, or some other systematic designation. The distance between the trails and or player positions can be designated by arrows with numerical annotation. The arrow designation may be used to illustrate the likely matchup coverage of defense and offense players. The width, shading or color of the arrows or lines can be varied depending on the distance or other coverage criteria. The video representation may key the current location of players so they appear to be on top of the shaded regions. The graphical image representation may be accompanied by images or icons for the players in the appropriate location on the playing surface.

According to an embodiment, information about a team or players of a team may be determined based on a motion of a first object relative to a motion of a set of athletes during a change of possession of a first object. For example, another measure regarding breakaways is a team's ability to guard against it while on offense. According to another embodiment, one indicator is a comparison between the locations relative to the team's goal for their defensive line against the opposing team's offensive line. For hockey, this can be the two defensemen on one team against the wings of the other team. Alternately, the comparison can include the centers on both teams. Match ups with distances close values between teams indicate a potential break away situation.

Another interesting measure is to determine how well the defense cuts off the offense in a breakaway. This can be determined by examining how straight a defender's pass is and whether the angle is appropriate to stop a shot. Measuring the shape of the player's trail can be used to detect line changes, according to a further embodiment. This is not only useful as part of a mechanism to maintain the roster off the ice, but it is also useful to decide what segments to ignore in computing a statistic or index. For example, it is not helpful to compute the distance between defensemen and wings on the opposing team during a line change.

One possible representation for an athlete, line, or team's ability to respond to changing circumstances in play can be called an RPM index. It can encompass the ability to accelerate quickly in response to transitioning from defense to offense, or in reverse. This can be measured in time to reach top speed from the moment of the turn over. The index also includes ability to maintain a high speed, measured in length of time the player is sprinting or skating.

Rating the defender closest to the goal, better known as the goalie, is of particular interest in hockey and soccer. Consideration of interest to the fans as well as coaching staff include among others: goalie position relative to shooter and goal, goalie position relative to defense and offense formation, goalie pose relative to time, location and speed of shot taken, measure goalie's reaction time (change pose or glove save), shooter angles versus success rate (scores and saves). Other measures include speed and distance of shots, the level of screens by the offense, the level of protection by the defense, and analysis of missed opportunities by offense. According to aspects of the invention, each of these considerations can be evaluated with system 100.

In an embodiment, an index or rating system to quantify a goalie's performance can include the contributing factors: percentage of time in proper position, amount of time a goalie is blocking a certain percentage of the net, number of shots from high percentage locations, number of shots from low percentage locations, goals against (high and low percentage), average time to react to a puck speed of shots and distance from goal tender, rebounds given up, shots as a result of a rebound, turnovers (playing the puck behind the net), number of times the puck is played, average time between shots, odd man rush shots/saves, one timer shot/saves, clutch saves during penalty kill, clutch saves at the beginning or end of a period (2 minutes into a period and 5 minutes prior to the end of a period).

An interesting problem for teams in organized sports is neutralizing the threat of a star or key offensive players on the opposing team. This often involves assigning dedicate coverage for the player, often involving using more than one defender. One measure for success is the space the star players are able to make while moving the puck (ball) or sending and receiving passes. This can be defined in terms of open area around the star or distance to the nearest defender, according to an embodiment. For soccer, hockey and basketball, this can be augmented by the number of passes received, number of passes made, number of shots taken, average time controlling puck/ball, frequency of contact with defenders (average time between hits in hockey). Each of these measures can be in turn used to determine how a star player performed or to select the key player in a game, according to further embodiments of the invention.

As previously discussed, data representations may be determined based on a relationship between an aspect of a first object and an aspect of a second object. In many cases, these data representations may include statistics and statistical measures. There are statistical measures for jumping for sports that encourages an athlete leaving the playing surface (basketball, Australian Rules Football, soccer, football). These include: hang times of a jump, distance covered in the air, average height of jump, maximum height of jump. In other embodiments, these can be determined by system 100.

Fighting is tolerated in hockey, and hence an index on fighting can be derived for fan amusement. In some embodiments, a rating system on the severity or victory of a bout can be found from a combination of the factors including length of fight in time/distance, referee involvement to stop fights (take down or break up), first and last punches landed, number punches thrown and landed, number punches received and take, rate and location of punches landed (face, body, equipment, etc.).

For sports that involved transitioning between regions of the playing field, it is helpful to index information according to general analysis of the flow of the play. According to aspects of the invention, measures that apply to hockey (and may be extended to other sports) include:

PUCK IN OFFENSIVE/DEFENSIVE ZONE: skaters on one side of the red line, typically all within the blue line. Linesmen and one referee typically stay between red and blue lines. A useful measure of team performance is the time the puck spends in the different offensive zones, and frequency entering and exiting the zones.

CHANGE IN POSSESSION: average skater position moves toward opposite zone, or reverse direction if zone transition is in progress. This ties with which team is on offense and defense. An interesting measure to the flow of a hockey, basketball or soccer game is the number of possession changes.

PLAY STOPPAGE: Large groups of players move toward and away from benches.

LINE CHANGES: Players leaving the ice often make direct trajectories to their bench. The transition typically happens on possession change (players migrating from one offensive zone to another). Discriminating between LW-C-RW and LD-RD lines can be assessed by role in team formation (front of pack vs. back of pack).

FACE-OFFS: Players congregate around a set range of points on ice and become stationary. Teams are limited to side corresponding to their own goal. In the neutral zone, wings and center line up and defensemen hold back. One defenseman lines up in the circle and other in front of goal.

POWER PLAY: the side at disadvantage typically has four players rotating in front of goal while attacking team stays at perimeter. Defensemen may be closer to goal, but positions are less definite.

PUCK LOCATION: the puck's position can be estimated by the convergence of players, particularly when near one of the goals. Player movement can be an indication of puck movement, which can be an indicator of offense/defense performance. Hence, it is useful to monitor this location over time.

ODD-MAN RUSHES: detection of breakaways, and statistics during these events can be strong indicators of player performance.

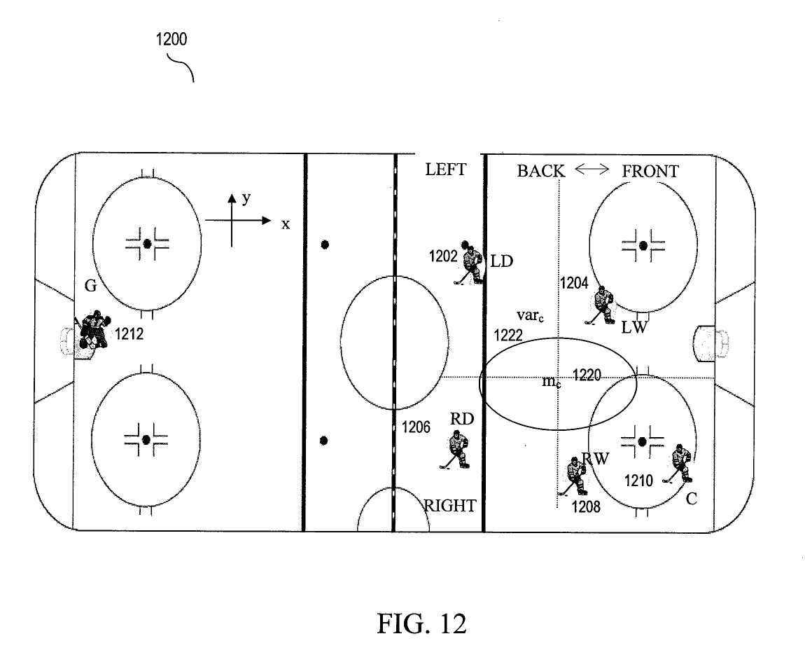

FIG. 12 illustrates basic statistical calculations based on the team formation, according to an embodiment. The team affiliation of athletes can often be identified based on uniform color. The skaters 1202-1212 on a team may be defined. The center of mass (m_{c}) 1220 from the skaters' locations may be computed, according to an embodiment. In a further embodiment, the distribution of the skaters can be computed using second order moments such as variance, denote in this case as var_{c} 1222. Note that the shape is oval to reflect the different distribution in the x and y directions.

Statistical formation analysis can indicate weakness, such as when the frequency of play favors the left side of the formation versus the right. This can be used to “tag” data to be reviewed by coaches and support staff. According to an embodiment, moment calculations can be applied to subsets of players, such as the defensive line, left side of playing surface, etc. Moment statistics can be computed in unison or separately with the other team.

A number of statistical measures can be derived by integrating spatial measures over time and space, according to an embodiment. One example is to compare the integration of an area in the offensive zone closest to the defense to an area closest to the offense. Alternately, the average x value or r value (distance from the goal) can be derived as a potential measure. If these measures are computed over time, this can be an indication how well the offense penetrates the zone. In a further embodiment, another measure can be integrating the shadow of defenders to assess what percentage of the shooting zone in covered by player positioning. By similar analysis, the space around the offense can be determined by integrating over the entire zone. Furthermore, puck and player speed can be used as part of this integration process.

As seen in FIG. 12, the role on the team can be ascertained from an athlete's general location. Goalies (G) 1212 will stay near the goal during play under normal circumstances, especially when member of the opposing team is nearby. They will usually be the closest player on the team to the front of the goal (when there is a goalie in the net). When the play is in the neutral or offensive zones, there is a separation between the goalie and the other members of the team. Players toward the left side of the ice (higher y values) will tend to be left defensemen (LD) 1202 and left wing (LW) 1204. In contrast, players on the right side of the ice (lower y values) will tend to be the right defensemen (RD) 1206 and right wing (RW) 1208. Naturally, the center (C) 1210 will tend to stay toward the center. This is particularly true when “carrying” the puck up the ice during an offensive attack.

The players on the goal side or “BACK” (lower x values) are typically defensemen, denoted LD 1202 and RD 1206 for Left and Right respectively. This is usually near the blue line of the offensive zone when the team is on offense. Shots made by defensemen are typically slap shots due to the typical distance to the goal. The players on the opposing goal side or “FRONT” (higher x values) are typically wings, denoted LW 1204 and RW 1208 for Left and Right Wing. This can be near the blue line of the defensive zone when the team is on defense. They typically locate there to cover the defensemen on the other team and prepare for a potential breakaway. The center (C) 1210 will support the Wings when the team is on offense (offensive zone) and support the defensemen when the team is on defense (defensive zone).

In one embodiment, data generated by formation analysis can be represented as a diagram over laying a video image or graphical image of the playing surface. This may include designating the combination of multiple player positions of either or a combination of both teams (1220) as a position annotated on the game field. The width, shading or color of the lines can be varied based on team affiliation. The distribution of the players can be designated as curved shape (1222) that varies in size and shape based on the spread of the player locations. The width, shading or color of the arrows or lines can be varied depending on the distance or other coverage criteria. Players can be annotated by their role according the team formation (RD, LD, RW, LW, C, G), or using the appropriate player number, identified by matching team role to the roster currently on the game field. The video representation may key the current location of players so they appear to be on top of the shaded regions. The graphical image representation may be accompanied by images or icons for the players in the appropriate location on the playing surface.

By similar analysis to above, the position of the officials in a hockey game can be estimated by position. The officials near the blue lines (linemen) have a consistent detail to mark up on the blues lines to make off sides calls. They tend to hold their positions except to get out the way of the puck and the play, and occasionally leave their posts to drop the puck for face-offs in the offensive zone. The referees are typically closest skater to the goal when the puck is in the neutral zone or other end of the ice. They tend to stay out of the way of the puck and main play, and move to the opposite side of the puck when the puck is on their end of the ice. Referees drop the puck at face-offs in center ice. The referees of other sports (basketball, soccer, etc.) tend to move in a systematic manner based on the location of the ball on the game field.

One interesting problem is determining reasonable statistical measures that are timely when there is uncertainty in the real-time information provided. For example, objects or athletes that are being tracked may be labeled for purposes of identification. Sometimes there can be gaps in the labeling of a track if automatic labeling is not successful and an operator has not provided labeling assistance. A potential example is that two defensemen come onto the ice in a line change, but not yet move into standard formation to enable identification of the defensemen. The statistics for LD (Q_{LD}) and RD (Q_{RD}) related to the measurements (Q₁ and Q₂) for this section of play can temporarily be determined from a weight combination of the two tracks:

Q_{LD}=(w)Q₁+(1−w)Q₂, Q_{RD}=(1−w)Q₁+(w)Q₂.

w is a scalar based of the likely association between the input measurements and track labels. It will have a value of 0.5 for cases where the association is not known. The above weighting will change with time: certainty can increase as the team assumes a cleaner formation; certainty can decrease if tracks cross the paths of multiple players. Probability of track continuity may be used as part of the weighting of track assignments. The weighting approach can be extended to cases where the uncertainty of labeling extends over more than two tracks. Weighting can be incorporated to balance the uncertainty between manually labeled and automatically labeled tracks.

In an effort to better understand a player's contribution to a team's result, statisticians developed Sabermetrics to help evaluate baseball players. Their goal was to measure the contributions of players to the games won and lost. Here, Sabermetrics is used to evaluate the past performance of a player and help predict the future performance. To do so the statistics must satisfy three questions. Almost every statistic has flaws and the best statistics are the ones with the only minor failings and the least amount of flaws.

First, “Does the statistic measure an important contribution to the goal?” The goal for all teams regardless of the sport is winning games. In baseball the pitcher's ERA, earned run average, measures the number of runs a pitcher allowed, thus showing a pitcher's contribution to the outcome. Similarly, in hockey the goalie's GAA, goals against average, shows how many goals were let in by the goalie. Each satisfies the first question and shows how they helped the team win or loss.

The next question to ask of a statistic is, “How well does the statistic measure the player's own contribution?” A good statistic should not measure outside effects that the player has no control over. Baseball's example of a poor statistic is runs scored, in how a player can only score, other than a homerun, by the contribution of his teammate. If the player does not have players behind him that can drive him in then the player on base isn't going to score many runs. Likewise, measuring hockey players on their assist totals is of little significance for players who do not have players on their line that can't score. The best passer in the world gets little recognition if the line mates cannot score goals as a result.

The third question to define a useful statistic is, “Is there a better way to measure the same statistic?” Some statistics may not satisfy the first two questions, however it may be useful if there is no other alternative. In hockey and other sports with goaltenders, one statistic that comes to mind is the save statistic. Goaltenders can accumulate a number of saves through out a game and record a high save percentage. However, the shots can be from bad angles or from far distances. According to an embodiment, a better measure for goaltenders would be to compute which shots and consequently which saves were of higher difficulty or from a closer range to determine how good the goaltender really is.

Sabermetrics may be applied to baseball in the form of an index as described above. For example, Pete Palmer produced an index for a player's ability to create runs using official baseball statistics:

Runs=(0.46*1B)+(0.80*2B)+(1.02*3B)+(1.40*HR)+(0.33*(BB+HBP))+(0.30*SB)+(−0.60*CS)+(−0.25*(AB−H))−(0.50*OOB),

where 1B stands for singles, 2B stands for doubles, 3B stands for triples, HR represents homeruns, BB is base on balls, or walks, HBP is for hit by pitch, SB for stolen bases, CS for times caught stealing, AB represents the number of at bats, H stands for hits, and OOB stands for out on base. Similarly, Sabermetric indices may be formulated for baseball and other sports by selecting a different target objective: “runs saved”, “goals created/saved”, “points created/saved”, “shots created/prevented”, etc. In one embodiment of this invention, Sabermetric indices are formulated from a first aspect of a first object and a second aspect of a second object. In another embodiment, Sabermetric indices are formulated using one or more enumerated statistics (singles, doubles, etc.) in combination with a first aspect of a first object and a second aspect of a second object. In yet another embodiment, Sabermetric indices are formulated from a first aspect of a first object and a second aspect of a second object, where the aspects are physical metrics.

Using a similar approach to baseball Sabermetrics, National Hockey League (NHL) statistics can be modified and enhanced to better describe a player's true value and to see the player's actual contributions to the team. Unfortunately, hockey is unlike baseball where every scenario and every play develops with enormous amounts of time in between. In this situation, the addition of player tracking data is vital to the success of the statistics to be derived. According to an embodiment, having positional data and information regarding the player's movement and puck possession will greatly enhance the statistics currently generated. Thus giving fans, players and teams a better understanding of the game and the value of the players within the game. In some embodiments, data representations based on a relationship between aspects of objects may be aided by player contribution statistics.

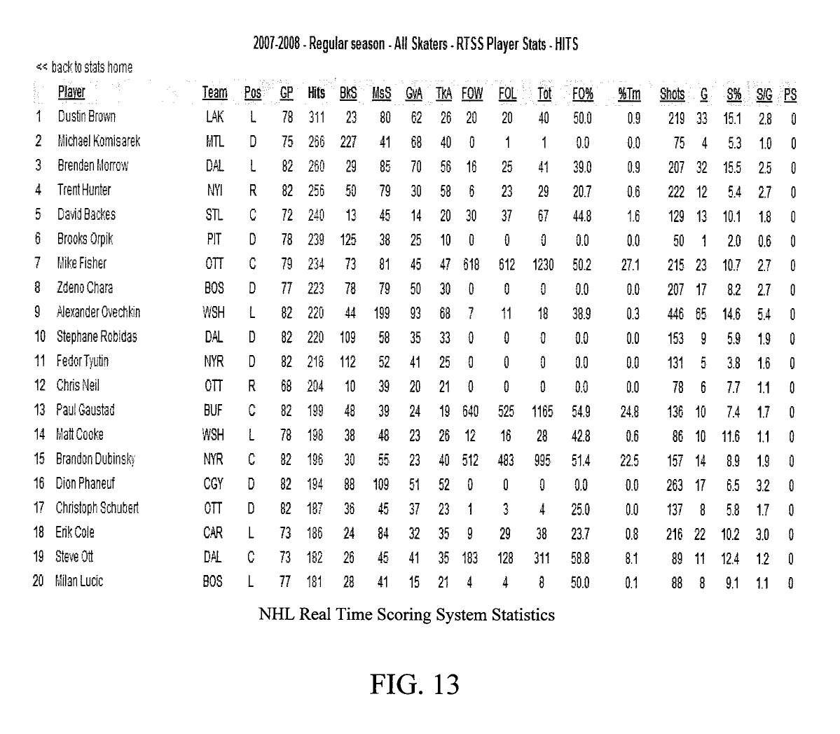

The example statistics shown in FIG. 13, recorded by league officials at all NHL games, have some deficiencies and are quite subjective. The majority of the statistics are appealing to fans of the sport but shed little light on a player's performance because of inaccuracies. For instance the Hits, Blocked Shots, Missed Shots, Give Away, and Take Away statistics are all based on an official's judgment. Officials in one arena may have a different idea as to what a hit or a take away is. There is no science backing what constitutes a hit or a clear statement defining a hit.

The Real-Time Scoring System (RTSS) provide data showing the number of times a player blocks a shot and the number of times a player misses the net with a shot. Both statistics can be skewed based on an official's ability to follow the puck. Numerous times throughout a game, shots are deflected and the original path of the puck can be slightly altered or blocked altogether. If the shot reaches the net it is a shot on goal. However if it is deflected slightly and misses the net it can be deemed either a missed shot or a blocked shot for a defender. The reason being the officials may or may not notice the deflection and are giving credit or taking away credit where it is rightfully deserved. In some embodiments, location or poses of officials may be evaluated relative to athletic events.

The third area of concern with the RTSS statistics is in defining a giveaway versus a takeaway. A giveaway is when a player's own actions result in a loss of puck possession to the opposition. A takeaway occurs when pressure from the defending team results in a defending player gaining possession of the puck. Both statistics are at the mercy of the official to deem whether the play was a result of the defensive player's or the offensive player's own actions. Defenders back checking an offensive player may cause an offensive player to lose control of the puck. Many times it is hard to see the defender performing such actions and a giveaway may be awarded. Similarly, a defender may gain the puck due to an offensive player losing control of the puck and could be rewarded with a takeaway despite not influencing the play.

Knowing player's positions and seeing their movement throughout a play can greatly increase the accuracy of these statistics. According to an embodiment, a player tracking system can clearly define and calculate a hit each and every time a collision occurs. In addition a player tracking system can see the original path of a shot and determine who if anyone altered its path towards the net. Puck possession can easily be determined when knowing each player's affiliate and seeing the player with the puck. Hits can be rewarded based on scientific evidence of the collision and the collisions intensity. Blocked shots and missed shots can be properly awarded based on the ability to see the path the puck travels and knowing where deflections occurred. Finally, a giveaway and a takeaway will resemble its definition, knowing when a player possesses the puck and when the opposition played a role in taking the puck away. These determinations can be determined using elements of system 100.

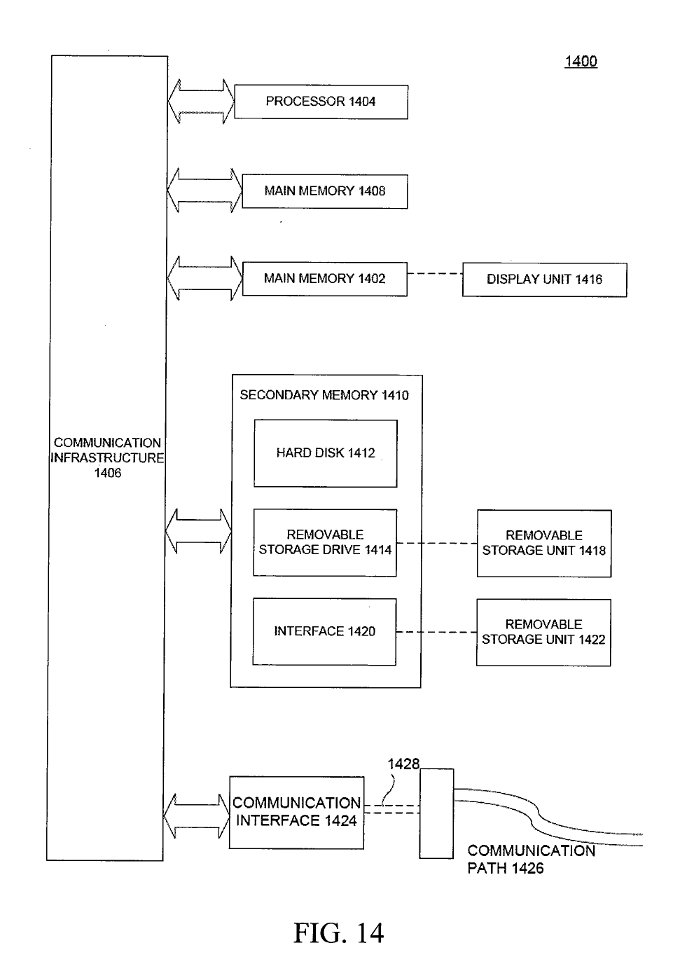

Aspects of the present invention, for exemplary systems 100 and 300-1200 and/or method 200 or any part(s) or function(s) thereof may be implemented using hardware, software modules, firmware, tangible computer readable or computer usable storage media having instructions stored thereon, or a combination thereof and may be implemented in one or more computer systems or other processing systems. FIG. 14 illustrates an example computer system 1400 in which the present invention, or portions thereof, can be implemented as computer-readable code. For example, sensor system 104, object tracker 110, data manager 140, track manager 120, data server 150, operator interface 112, stats feed 130, client 160 and/or any other components of exemplary system 100 can be implemented in hardware, firmware, or as computer-readable code on a computer system such as computer system 1400. After reading this description, it will become apparent to a person skilled in the relevant art how to implement the invention using other computer systems and/or computer architectures.

Computer system 1400 includes one or more processors, such as processor 1404. Processor 1404 can be a special purpose or a general purpose processor. Processor 1404 is connected to a communication infrastructure 1406 (for example, a bus or network).

Computer system 1400 also includes a main memory 1408, preferably random access memory (RAM), and may also include a secondary memory 1410. Secondary memory 1410 may include, for example, a hard disk drive 1412 and/or a removable storage drive 1414. Removable storage drive 1414 may comprise a floppy disk drive, a magnetic tape drive, an optical disk drive, a flash memory, or the like. The removable storage drive 1414 reads from and/or writes to a removable storage unit 1418 in a well known manner. Removable storage unit 1418 may comprise a floppy disk, magnetic tape, optical disk, etc. which is read by and written to by removable storage drive 1414. As will be appreciated by persons skilled in the relevant art(s), removable storage unit 1418 includes a computer usable storage medium having stored therein computer software and/or data.

In alternative implementations, secondary memory 1410 may include other similar means for allowing computer programs or other instructions to be loaded into computer system 1400. Such means may include, for example, a removable storage unit 1422 and an interface 1420. Examples of such means may include a program cartridge and cartridge interface (such as that found in video game devices), a removable memory chip (such as an EPROM, or PROM) and associated socket, and other removable storage units 1422 and interfaces 1420 which allow software and data to be transferred from the removable storage unit 1422 to computer system 1400.

Computer system 1400 may also include a communications interface 1424. Communications interface 1424 allows software and data to be transferred between computer system 1400 and external devices. Communications interface 1424 may include a modem, a network interface (such as an Ethernet card), a communications port, a PCMCIA slot and card, a wireless card, or the like. Software and data transferred via communications interface 1424 are in the form of signals which may be electronic, electromagnetic, optical, or other signals capable of being received by communications interface 1424. These signals are provided to communications interface 1424 via a communications path 1426. Communications path 1426 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1418, removable storage unit 1422, a hard disk installed in hard disk drive 1412, and signals carried over communications path 1426. Computer program medium and computer usable medium can also refer to memories, such as main memory 1408 and secondary memory 1410, which can be memory semiconductors (e.g. DRAMs, etc.). These computer program products are means for providing software to computer system 1400.

Computer programs (also called computer control logic) are stored in main memory 1408 and/or secondary memory 1410. Computer programs may also be received via communications interface 1424. Such computer programs, when executed, enable computer system 1400 to implement the present invention as discussed herein. In particular, the computer programs, when executed, enable processor 1404 to implement the processes of the present invention, such as the steps in the method illustrated by flowchart 200 of FIG. 2 discussed above. Accordingly, such computer programs represent controllers of the computer system 1400. Where the invention is implemented using software, the software may be stored in a computer program product and loaded into computer system 1400 using removable storage drive 1414, interface 1420, hard drive 1412 or communications interface 1524.

Embodiments of the invention also may be directed to computer products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method of generating information from an athletic event comprising:
receiving a first aspect of a first object in the athletic event;
receiving a second aspect of a second object in the athletic event;
determining a data representation with a processor based on the first aspect of the first object relative to the second aspect of the second object; and
storing the data representation in a data server.

2. The computer implemented method of claim 1, wherein at least one of the first aspect and second aspect is recorded using a sensor system.

3. The computer-implemented method of claim 1, wherein the receiving a first aspect includes receiving a location of a first object, and the receiving a second aspect includes receiving a location of a second object.

4. The computer-implemented method of claim 3, wherein the receiving a location of a first object includes receiving a location of a set of athletes within a time window, and wherein the receiving a location of a second object includes receiving a location of a second set of athletes within the time window, and wherein the determining a data representation includes analyzing a formation or play of at least one of the first set of athletes or the second set of athletes.

5. The computer-implemented method of claim 1, wherein the receiving a first aspect includes receiving a location of a first object, and the receiving a second aspect includes receiving a motion of a second object.

6. The computer-implemented method of claim 5, wherein the receiving a motion of a second object includes receiving one or more locations or measurements of the second object at one or more points in time.

7. The computer-implemented method of claim 1, wherein the receiving a first aspect includes receiving a pose of a first object, and the receiving a second aspect includes receiving a location of a second object.

8. The computer-implemented method of claim 1, wherein the receiving a first aspect includes receiving a pose of a first object, and the receiving a second aspect includes receiving a motion of a second object.

9. The computer-implemented method of claim 1, wherein the receiving a first aspect includes receiving a pose of a first object, and the receiving a second aspect includes receiving a pose of a second object.

10. The computer-implemented method of claim 1, wherein the determining includes receiving one or more official or player contribution statistics of an athlete.

11. The computer-implemented method of claim 1, wherein the receiving a first aspect includes receiving a motion of a first object, and the receiving a second aspect includes receiving at least one of a size, shape, time duration, or frequency of an area that the first object passes through.

12. The computer-implemented method of claim 1, wherein the receiving a first aspect includes receiving a motion of a first object, and the receiving a second aspect includes receiving a pose of an athlete in the athletic event between a starting point of a motion of the first object and an ending point target of the motion.

13. The computer-implemented method of claim 1, wherein the receiving a first aspect includes receiving a motion of a first object, and the receiving a second aspect includes receiving a location, motion or pose of an athlete within a time window of a disruption of the motion of the first object from an initial trajectory.

14. The computer-implemented method of claim 1, wherein the receiving a first aspect includes receiving a motion of a first object, and the receiving a second aspect includes receiving a location, motion or pose of an athlete in a time window of an athletic action.

15. The computer-implemented method of claim 1, wherein the receiving a first aspect includes receiving a motion of a first object, and wherein the receiving a second aspect includes receiving a formation of a set of athletes in the athletic event, and wherein the determining a data representation includes determining or evaluating a play.

16. The computer-implemented method of claim 1, wherein the receiving a first aspect of a first object includes receiving an action of a first athlete, and wherein the receiving a second aspect of a second object includes receiving a reaction of a second athlete, and wherein the reaction of the second athlete is in response to the action of the first athlete.

17. The computer-implemented method of claim 1, wherein the receiving a first aspect includes receiving a motion of a first object, and wherein the receiving a second aspect includes receiving a motion of a set of athletes in the athletic event during a change of possession of a first object.

18. The computer-implemented method of claim 1, wherein the receiving a first aspect includes receiving a location and pose of an athlete in the athletic event proximate to an object within a time window of a an offensive or defensive action in the athletic event.

19. The computer-implemented method of claim 1, wherein the receiving a first aspect includes receiving at least one of a size, shape, time duration, or frequency of an area of a playing surface proximate to a first athlete.

20. The computer-implemented method of claim 1, wherein the determining a data representation includes determining at least one of a location, size, or shape of an area created as a result of the relationship between the first aspect of the first object and the second aspect of the second object.

21. The computer-implemented method of claim 1, wherein the receiving a first aspect includes receiving a location and pose of a first athlete in the athletic event, and the receiving a second aspect includes receiving a location of a second athlete in the athletic event having possession of a scoring object.

22. The computer-implemented method of claim 1, wherein the receiving a first aspect includes receiving a location, motion and pose of a first athlete in the athletic event that is in preparation for receiving an object, and the receiving a second aspect includes receiving a location of a second athlete in the athletic event having possession of an object.

23. The computer implemented method of claim 1, wherein the determining a data representation includes generating an index.

24. A computer-implemented method of generating information from an athletic event comprising:
receiving a first aspect of a first object in the athletic event;
receiving a second aspect of a second object in the athletic event;
determining a data representation with a processor based on the first aspect of the first object relative to the second aspect of the second object; and
displaying an image based on the data representation.

25. The computer-implemented method of claim 24, wherein the displaying includes displaying the image during the athletic event.

26. The computer-implemented method of claim 24, wherein the displaying includes displaying the image subsequent to the athletic event.

27. The computer-implemented method of claim 24, wherein the displaying includes displaying the image within a larger image of the event.

28. A system for generating information from an athletic event comprising:
an object tracker configured to determine a first aspect of a first object and a second aspect of a second object; and
a data manager configured to determine a data representation based on the first aspect of the first object relative to the second aspect of the second object.

29. The system of claim 28, further comprising a sensor system configured to receive information about a first object and a second object.

30. The system of claim 28, further comprising a renderer configured to display an image based on the data representation.

31. The system of claim 30, wherein the renderer is further configured to display the image within a larger image of the event.

32. The system of claim 28, further comprising a data server configured to store the data representation.

33. The system of claim 28, wherein the object tracker is configured to record a location of one or more objects in the athletic event.

34. The system of claim 28, wherein the object tracker is configured to record a motion of one or more objects in the athletic event.

35. The system of claim 28, wherein the object tracker is configured to record a pose of one or more athletes in the athletic event.

36. The system of claim 28, wherein each respective aspect is recorded relative to a time reference of the athletic event.

37. The system of claim 28, wherein the object tracker is configured to record at least one of a size, shape, time duration, or frequency of an area proximate to the first object of the athletic event.
